(19) United States
(12) Patent Application Publication
(10) Pub. No.: US 2026/0330837 A1
(43) Pub. Date: Oct. 22, 2026

(54) SYSTEMS AND METHODS FOR LAYERED SURVEILLANCE

(71) Applicant: S.E.R.P.E.N.T Industries, Sarasota, FL (US)

(72) Inventors: Michael Casarona, Sarasota, FL (US); Michael McCarty, Orefield, PA (US)

(21) Appl. No.: 19/652,354

(22) Filed: Apr. 20, 2026

Related U.S. Application Data
(60) Provisional application No. 63/791,129, filed on Apr. 18, 2025.

(51) Int. Cl. G06V 20/52; G06F 40/40; G06T 7/246; G06T 7/277; G06T 7/73; G06V 10/25; G06V 10/764; G06V 10/82; G06V 20/40; G06V 20/62; G06V 30/19; G06V 40/16; G06V 40/20; G10L 25/51

(52) U.S. Cl. CPC G06V 20/52; G06F 40/40; G06T 7/248; G06T 7/277; G06T 7/74; G06V 10/25; G06V 10/764; G06V 10/82; G06V 20/41; G06V 20/625; G06V 30/19; G06V 40/171; G06V 40/172; G06V 40/20; G10L 25/51; G06T 2207/20084; G06T 2207/30201; G06T 2207/30241

(57) ABSTRACT

Provided herein is a layered surveillance system and method, the layered surveillance system including: at least one camera, wherein the at least one camera is configured to capture a plurality of frames of video data; at least one processor; and a memory communicatively connected to the at least one processor, wherein the memory contains instructions configuring the at least one processor to: receive the plurality of frames of video data from the at least one camera; identify people in the plurality of frames using a person detection model; determine an active threat score using an active threat detection process; determine a safety score using a safety detection process; and perform a facial recognition process.

### CROSS REFERENCE TO RELATED APPLICATIONS

This application claims the benefit of priority to U.S. Provisional Patent Application No. 63/791,129, filed on Apr. 18, 2025, and entitled “AI-POWERED SECURITY SYSTEM,” the entirety of which is incorporated herein by reference.

### FIELD OF THE INVENTION

The present disclosure is directed generally to monitoring systems. Particularly, the present disclosure is directed to systems and methods for layered surveillance.

### BACKGROUND OF THE INVENTION

Historically, traditional surveillance and conventional monitoring systems provide passive surveillance by recording activity. However, the conventional monitoring systems employed historically fails to provide, enhanced security and further protection features which evidences a disadvantage in that there is passive surveillance in these systems that simply monitor on its face.

Therefore, the need exists for a security, surveillance system that ensures faster responses and greater situational awareness by analyzing, predicting, and responding to potential threats in real time.

Accordingly, there remains a need in the art for surveillance systems that improve upon existing systems for surveillance. The present disclosure meets this need.

### SUMMARY

In some aspects, the techniques described herein relate to a layered surveillance system, the layered surveillance system including: at least one camera, wherein the at least one camera is configured to capture a plurality of frames of video data; at least one processor; and a memory communicatively connected to the at least one processor, wherein the memory contains instructions configuring the at least one processor to: receive the plurality of frames of video data from the at least one camera; identify people in the plurality of frames using a person detection model, wherein the person detection model includes a neural network configured to: receive, as input, the plurality of frames; and output a bounding box and confidence score for each person identified in the plurality of frames; determine an active threat score using an active threat detection process, wherein the active threat detection process includes: an object detection algorithm configured to generate an object score using an object detection neural network; a threat action recognition algorithm trained on a set of behavior classes pertaining to threat assessment and configured to receive a sequence of the plurality of frames as input and output a suspicious behavior score; an active threat score rollup configured to combine the object score and the suspicious behavior score into the active threat score; determine a safety score using a safety detection process, wherein the safety detection process includes: a hazard detection algorithm configured to generate a hazard score using a hazard-detection neural network; a safety action recognition algorithm trained on a set of behavior classes pertaining to safety risk assessment and configured to receive a sequence of the plurality of frames as input and output a dangerous behavior score; a safety score rollup configured to combine the hazard score and the dangerous behavior score into the safety score; performing a facial recognition process, wherein the facial recognition process includes: generating a facial embedding for each bounding box; comparing each facial embedding against a facial embedding set; and assigning a unique identifier to a bounding box as a function of a comparison between the facial embedding and the facial embedding set.

In some aspects, the techniques described herein relate to a layered surveillance method, the layered surveillance method including: receiving, by at least one processor, a plurality of frames of video data from at least one camera; identifying, by the at least one processor, people in the plurality of frames using a person detection model, wherein the person detection model includes a neural network configured to: receive, as input, the plurality of frames; and output a bounding box and confidence score for each person identified in the plurality of frames; determining, by the at least one processor, an active threat score using an active threat detection process, wherein the active threat detection process includes: an object detection algorithm configured to generate an object score using an object detection neural network; a threat action recognition algorithm trained on a set of behavior classes pertaining to threat assessment and configured to receive a sequence of the plurality of frames as input and output a suspicious behavior score; and an active threat score rollup configured to combine the object score and the suspicious behavior score into the active threat score; determining, by the at least one processor, a safety score using a safety detection process, wherein the safety detection process includes: a hazard detection algorithm configured to generate a hazard score using a hazard-detection neural network; a safety action recognition algorithm trained on a set of behavior classes pertaining to safety risk assessment and configured to receive a sequence of the plurality of frames as input and output a dangerous behavior score; and a safety score rollup configured to combine the hazard score and the dangerous behavior score into the safety score; performing, by the at least one processor, a facial recognition process, wherein the facial recognition process includes: generating a facial embedding for each bounding box; comparing each facial embedding against a facial embedding set; and assigning a unique identifier to a bounding box as a function of a comparison between the facial embedding and the facial embedding set.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 shows a flow diagram of a layered surveillance system;

FIG. 2 shows a flow diagram of an exemplary embodiment of a passive threat detection process is shown;

FIG. 3 shows a flow diagram of an exemplary embodiment of a reverse name search;

FIG. 4 shows a flow diagram of an exemplary embodiment of a results rollup process;

FIG. 5 shows a flow diagram of a secondary search script;

FIG. 6 shows a flow diagram of a dataset cleaner script;

FIG. 7 shows a flow diagram of an exemplary embodiment of a active threat detection process;

FIG. 8 shows a flow diagram of an exemplary embodiment of a safety detection process;

FIG. 9 shows a flow diagram of an exemplary embodiment of a facial recognition process;

FIG. 10 shows a flow diagram of an exemplary log and notification process;

FIG. 11 shows a flow diagram of an exemplary encode new face process;

FIG. 12 shows an exemplary embodiment of a machine-learning module;

FIG. 13 shows an exemplary embodiment of a neural network;

FIG. 14 shows a flow diagram of an exemplary method for layered surveillance; and

FIG. 15 shows an embodiment of a computing device in the exemplary form of a computer system.

### DETAILED DESCRIPTION

### Definitions

As used herein, each of the following terms has the meaning associated with it in this section. Unless defined otherwise, all technical and scientific terms used herein generally have the same meaning as commonly understood by one of ordinary skill in the art to which this disclosure belongs. Generally, the nomenclature used herein are those well-known and commonly employed in the art. It should be understood that the order of steps or order for performing certain actions is immaterial, so long as the present teachings remain operable. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the application, where an element or component is said to be included in and/or selected from a list of recited elements or components, it should be understood that the element or component can be any one of the recited elements or components and can be selected from a group consisting of two or more of the recited elements or components.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used herein, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

As used herein, the term “ratio” refers to a relationship between two numbers (e.g., scores, summations, and the like). Although, ratios can be expressed in a particular order (e.g., a to b or a: b), one of ordinary skill in the art will recognize that the underlying relationship between the numbers can be expressed in any order without losing the significance of the underlying relationship, although observation and correlation of trends based on the ration may need to be reversed. For example, if the values of a over time are (4, 10) and the values of b over time are (2, 4), the ratio a:b will equal (2, 2.5), while the ratio b:a will be (0.5, 0.4). Although the values of a and b are the same in both ratios, the ratios a:b and b:a are inverse and increase and decrease, respectively, over the time period.

### DETAILED DESCRIPTION

The present disclosure is directed to an AI-powered security system. The present disclosure may include a method of surveillance that analyzes, predicts and responds to potential threats in real time. Furthermore, the present disclosure may include automated threat detection, forensic data synthesis, real-time object recognition, and emergency response coordination-all aimed at eliminating blind spots and enhancing protection.

The present invention solves problems experienced with the prior art because it provides a security, surveillance system that ensures faster responses and greater situational awareness by analyzing, predicting, and responding to potential threats in real time. Those and other advantages and benefits of the present invention will become apparent from the detailed description of the invention hereinbelow.

The system described herein may include an intelligent, camera-agnostic surveillance platform that may process live video feeds from one or more cameras and applies real-time AI-driven analysis. It may detect and track individuals and objects of interest, performs facial recognition, and evaluates observations for potential security threats and safety hazards. The system may maintain evolving identity profiles through automated data capture and supports configurable, automated responses (such as alerting, access control, IoT integrations, etc.) based on recognition results and contextual analysis.

The system may include a layered processing pipeline in which raw video streams may be first ingested and then passed through a set of shared artificial intelligence models for efficient, centralized analysis. Detected entities may be persistently tracked across frames and, when applicable, across multiple camera views to maintain continuity of identity and behavior. The processed data may then be distributed to a series of independent but parallel analysis pipelines, including but not limited to, active threat detection, safety detection, and facial recognition; each operating on the same underlying data stream. These pipelines may generate structured outputs, such as risk scores, classifications, identification results, etc., which collectively drive real-time alerting, automated system responses, and comprehensive event logging.

The architecture may be optimized for computational efficiency by leveraging shared access to resource-intensive AI models across all active camera streams, minimizing redundant processing while maximizing throughput. At the same time, the architecture, in some embodiments, may enforce strict isolation wherever localized state or contextual integrity must be preserved, including at the camera, group, and user levels. This may allow the system to maintain accurate tracking, identity continuity, and context-aware analysis across different environments.

The platform may be designed to scale seamlessly to support a wide range of concurrent deployments, from individual users to large, multi-site enterprise clients. Rather than enforcing isolation strictly at the user level, the system may support flexible segmentation through independently managed pipeline instances that can be scoped to a user, a group of cameras (such as a home, building, or facility), or an entire organization. This may ensure that workloads, data processing, and contextual state remain consistent and independent within each defined scope.

In some embodiments, the layered isolation model may guarantee that user and organizational data (as non-limiting examples, such as detection results, identity profiles, event logs, etc.), remain securely partitioned, preventing cross-tenant interference or data leakage. At the same time, shared infrastructure and dynamic resource allocation enable the system to maintain high performance and responsiveness, allowing it to scale efficiently as additional users, locations, and camera networks are introduced.

### Data Ingestion and Processing

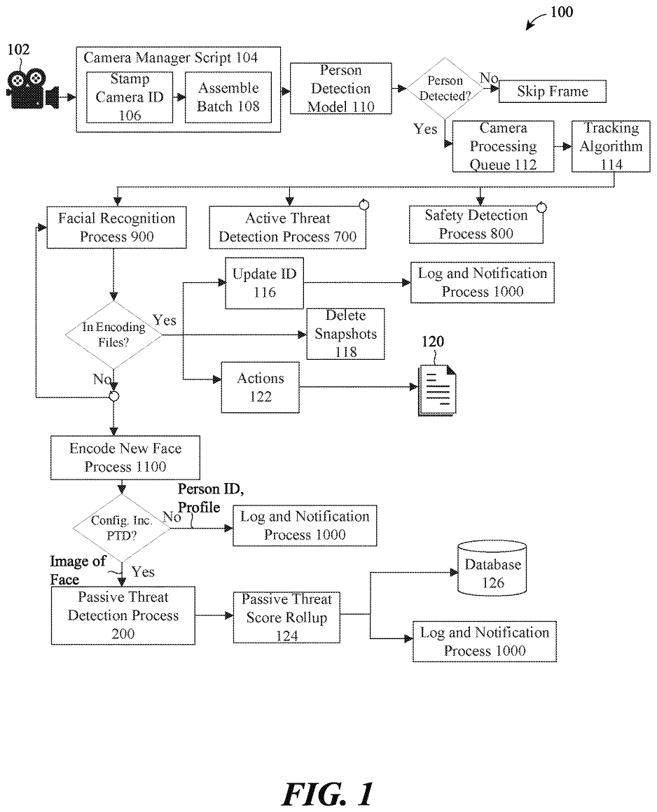

Referring now to FIG. 1, a layered surveillance system 100 is shown. Layered surveillance system 100 may include at least one camera 102. In some cases, a camera may include one or more optics. Exemplary non-limiting optics include spherical lenses, aspherical lenses, reflectors, polarizers, filters, windows, aperture stops, and the like. In some embodiments, one or more optics associated with a camera may be adjusted in order to, in non-limiting examples, change the zoom, depth of field, and/or focus distance of the camera. In some embodiments, one or more of such settings may be configured based on a parameter set, as described below. In some embodiments, at least a camera may include an image sensor. Exemplary non-limiting image sensors include digital image sensors, such as without limitation charge-coupled device (CCD) sensors and complimentary metal-oxide-semiconductor (CMOS) sensors. In some embodiments, a camera may be sensitive within a non-visible range of electromagnetic radiation, such as without limitation infrared.

With continued reference to FIG. 1, at least one camera 102 may include a plurality of cameras. Plurality of cameras may include 2-50 cameras. Plurality of cameras may include 5 cameras. Plurality of cameras may include 10 cameras. Plurality of cameras may include 25 cameras. At least one camera 102 may include, as non-limiting examples, surveillance cameras, security cameras, doorbell cameras, or video cameras.

With continued reference to FIG. 1, at least one camera 102 may be configured to capture a plurality of fames of video data. Plurality of frames include frames in a video; such that, when frames are sequentially displayed at the requisite speed, the illusion of motion is created. Each frame of video data may be static images.

With continued reference to FIG. 1, layered surveillance system 100 may ingest live video streams from one or more cameras 102. In some embodiments, one or more cameras 102 may be associated with a given user. These may include individual devices or logically grouped camera networks (e.g., by location or property). In some embodiments, a user may need to completed an the initial setup process, including, as non-limiting examples, account creation, camera integration, grouping of cameras by location or use case, and configuration of system preferences and operational parameters in order to use layered surveillance system 100.

With continued reference to FIG. 1, in some embodiments, each camera 102 of the plurality of cameras is configured to output a camera stream. A camera stream is a data stream including video data. In some embodiments, layered surveillance system 100 may be configured to convert RSTP streams to WebRTC streams for further processing.

With continued reference to FIG. 1, layered surveillance system 100 may include at least one processor. Layered surveillance system 100 may include memory communicatively connected to the at least one processor. The memory may contain instructions configuring the at least one processor to perform one or more actions as described throughout this disclosure.

With continued reference to FIG. 1, layered surveillance system 100 may include circuitry such as without limitation a processor communicatively connected to a memory; for instance, circuitry may include and/or be included in a computing device. As used in this disclosure, “communicatively connected” means connected by way of a connection, attachment, or linkage between two or more relata such as without limitation electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Circuitry may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure.

With continued reference to FIG. 1, processor may be designed and/or configured to perform any method, method step, or sequence of method steps in any embodiment described in this disclosure, in any order and with any degree of repetition. For instance, processor may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, plurality of frames of video data and/or camera streams may be processed using camera manager script 104. The camera manager script 104 may include a coordination process that sits between raw camera streams and all downstream processing. Camera manager script 104 may ensure frames are correctly identified, rate-controlled, and/or delivered to downstream components in a consistent, well-formed structure. Additional exemplary duties of camera manager script 104 may include but are not limited to, frame rate throttling, stream health monitoring, and initialization parameter management.

With continued reference to FIG. 1, camera manager script 104 may be configured to stamp camera identifiers 106 on frames received from cameras 102. This may include tagging each frame received from the camera 102 with a camera identifier associated with that camera 102. In some embodiments, camera manager script 104 may be run at the point of capture. Camera manager script 104 may tag each frame with a Unix time stamp. Camera manager script 104 may be configured to assign an incrementing sequence number to each frame received from camera 102. For example, a first frame processed by camera manager script 104 may be assigned an incrementing sequence number of 1, a next frame processed by camera manager script 104 may be assigned an incrementing sequence number of 2, and so on. In some embodiments, incrementing sequence numbers used by camera manager script 104 may be configured to periodically reset or reset when a condition is met. In some embodiments, frames that have been stamped with camera identifiers, timestamps, or incrementing sequence numbers may be referred to as a “stamped frame.” This may produce a stamped frame that may travel through the entire pipeline, ensuring every downstream component (tracker, analyzer, alert system, etc.) knows the exact origin of the data it is processing.

With continued reference to FIG. 1, camera manager script 104 may be configured to assemble batches 108 of frames. Camera manager script 104 may assemble one frame from each healthy camera stream into a single batch structure. A configurable timeout may be implemented top prevent a slow or unresponsive camera from delaying the batch for all other cameras. The assembled batch may then, in some embodiments, be passed as a single unit to person detection model 110.

With continued reference to FIG. 1, layered surveillance system 100 may interface with one or more APIs. APIs may include, as a non-limiting example, smart home & IoT integration APIs. For example, these APIs may integrate with a smart home hub which integrates with Amazon Alexa, Google Home, Apple HomeKit, and other ecosystems to trigger lights, alarms, and device actions. For example, these APIs may integrate with smart lock control which triggers automated lock/unlock actions on connected smart locks based on threat assessments. For example, these APIs may integrate with an alarm system which interfaces with existing alarm systems to activate or escalate alerts based on Spectre's threat analysis.

### Person Detection

With continued reference to FIG. 1, layered surveillance system 100 may be configured to identify people in the plurality of frames using person detection model 110. In some embodiments, person detection model 110 comprises a neural network configured to receive, as input, the plurality of frames. In some embodiments, the neural network may receive the assembled batches of frames. Neural network may be configured to output a bounding box and confidence score for each person identified in the plurality of frames. For example, bounding box may surround a face or body of a person. Confidence score indicate how confident person detection model 110 is in its detection of a person. In some embodiments, neural network may include a convolutional neural network.

With continued reference to FIG. 1, person detection model 110 may include a YOLO (You Only Look Once) convolutional neural network model for real-time person detection. YOLO includes a single-stage object detector that processes an entire image in a single forward pass, producing bounding box coordinates, class labels, and confidence scores for all detected objects simultaneously. This architecture is particularly well-suited to real-time multi-camera processing.

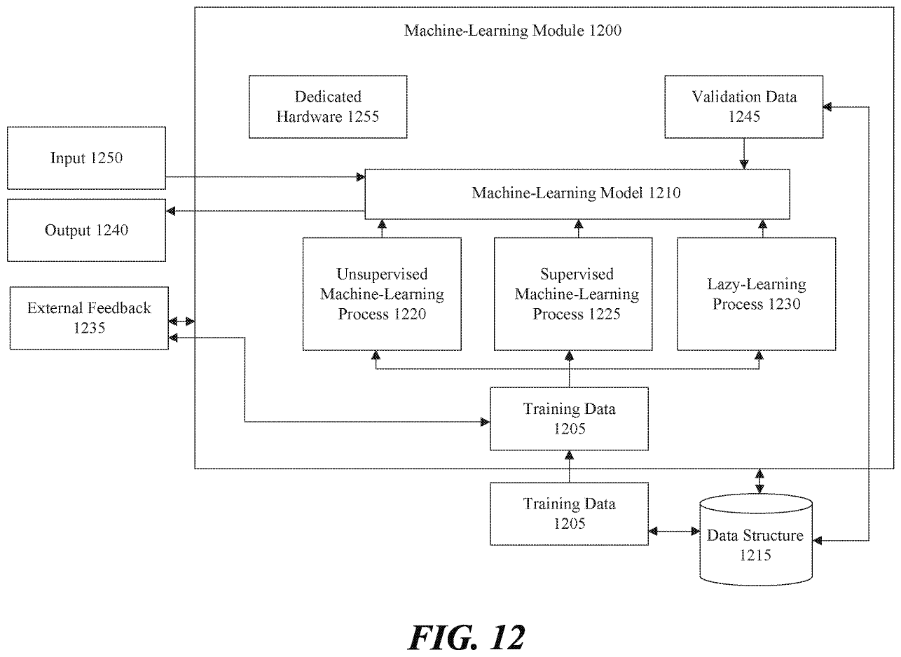

With continued reference to FIG. 1, in some embodiments, person detection model 110 may be trained using training data including frames correlated to labeled frames, wherein the labeling may indicate the presence and/or location of people in the frame. Person detection model 110 may be trained using a machine-learning module as described further with reference to FIG. 12.

With continued reference to FIG. 1, in some embodiments, layered surveillance system 100 may, rather than processing each camera feed independently, stack frames from all cameras into a single batched tensor and performs one GPU forward pass. Person detection model 110 may return a list of detection results with one entry per input frame, preserving the correspondence between each result and its originating camera using the StampedFrame structure. This approach represents a technical improvement as it may maximize GPU utilization and minimize total inference latency. In some embodiments, person detection model 110 may be configured at initialization, as non-limiting examples, with a confidence threshold below which detections are discarded, a target class filter (person class only, or extended to include vehicles and animals as required), and a minimum bounding box size to filter out distant or partial detections.

With continued reference to FIG. 1, If a person is detected, the output of person detection model 110, in some embodiments, may be the frames enriched with: detected bounding boxes, confidence scores per detection, and/or class labels. In some embodiments, if no person is detected, the frame set is skipped and no downstream processes are called.

With continued reference to FIG. 1, in some embodiments, frames with bounding boxes may be received in camera processing queue 112 if a person is detected in the fame. Camera processing queue 112 may include a dedicated first-in-first-out queue. Camera processing queue 112 may serve as a buffer that decouples the batched output of the YOLO model (which comes in bursts) from the continuous per-camera processing of the downstream trackers. Without this buffering layer, a slow tracker on one camera would block YOLO from processing the next batch for all cameras. In some embodiments, camera processing queue 112 may perform no transformation of the data. In some embodiments, the sole function of camera processing queue 112 may be temporal decoupling and flow control. Each queue is consumed independently by its corresponding per-camera tracker.

### Tracking Algorithm

With continued reference to FIG. 1, layered surveillance system 100 may include a tracking algorithm 114. Tracking algorithm 114 may be configured to match each bounding box to an existing tracked entity. In some embodiments, tracking algorithm 114 may include a Deep Simple Online and Realtime Tracking (DeepSORT) algorithm. In some embodiments, each camera 102 may have its own instance of tracking algorithm 114. DeepSORT extends the SORT tracking algorithm by incorporating a deep appearance descriptor to improve the association of detections across frames, particularly in cases of occlusion or temporary disappearance from frame. Deep appearance descriptor may include a compact neural network embedding of a person's visual appearance.

With continued reference to FIG. 1, layered surveillance system 100 may be configured to calculate a deep appearance descriptor for the existing tracked entity using a neural network. For example, a vector representing the existing tracked entity may be fed into an embedding neural network as input. The embedding neural network may apply a first transformation to the input; the transformation may be a linear transformation. For example, in some embodiments, the input may be multiplied by weight matrix. Weight matrix may be learned during training of the embedding neural network. Then, the vector may be passed through one or more hidden layers, wherein each hidden layer may apply an activation function. Then, embedding neural network may include a compression layer, wherein the compression layer is narrower than the layer that came before. This may force the embedding neural network to discard irrelevant or low-relevance information. In some embodiments, deep appearance descriptors may be calculated using OSNet or FastReID.

With continued reference to FIG. 1, tracking algorithm 114 may be configured to predict a location of an existing tracked entity using a Kalman filter. Location prediction using a Kalman filter may be performed by representing the motion of an object as a discrete-time dynamic system in which a latent state vector encodes position, velocity, and, optionally, higher-order kinematic terms, and by iteratively applying a prediction-update cycle to estimate said state from noisy observations. In a prediction phase, a prior state estimate is propagated forward in time according to a motion model using a state transition matrix and process noise covariance to account for uncertainty in system dynamics, thereby producing a predicted state and associated error covariance.

With continued reference to FIG. 1, for each incoming frame, tracking algorithm 114 may attempt to match each new bounding box detection to an existing tracked person using a combination of Kalman filter-predicted position (motion model) and cosine distance between appearance embeddings (appearance model). Tracking algorithm 114 may include comparing the predicted location of the existing tracked entity to a location of the bounding box and comparing the deep appearance descriptor for the existing tracked entity to an embedding of the bounding box. Detections that match an existing track may continue that track. Detections that do not match any existing track may be initialized as new tracks with a new unique tracking ID. Tracks may be maintained across frames even when a person is temporarily undetected, using the Kalman filter to predict their likely position. Tracks that remain unmatched beyond a configurable number of frames may be marked as lost and eventually deleted. A configurable minimum number of consecutive matched frames may be required before a new track is considered confirmed, suppressing spurious ghost tracks from noise detections.

With continued reference to FIG. 1, in some embodiments, tracking state may be camera-local, meaning that a person's track on camera 1 may have no relationship to any track on camera 3 until a cross-camera re-identification stage reconciles them into a single identity. Each tracking algorithm 114 instance may be initialized independently and maintains its own track state, Kalman filter parameters, and appearance embedding history. Because each camera's tracking algorithm 114 may operate independently, the same physical person appearing across multiple cameras may receive different per-camera tracking IDs. A cross-camera re-identification layer may be used to addresses this by comparing appearance embeddings (compact numerical representations of a person's visual appearance produced by models such as OSNet or FastReID) across all active tracks using cosine similarity. When a new track appears, it may be matched to an existing canonical tracking ID if similarity exceeds a configured threshold, or assigned a new one if no match is found. This may ensure that downstream analysis (such as Active Threat Detection, Safety Detection, Facial Recognition, etc.) can correlate detections and recognitions associated with the same individual across the entire camera network. The output of tracking algorithm 114 may include a Stamped Frame enriched with: tracking ID (per-camera), bounding box, appearance embedding, and/or track age (frames since first detection).

### Passive Threat Detection Process

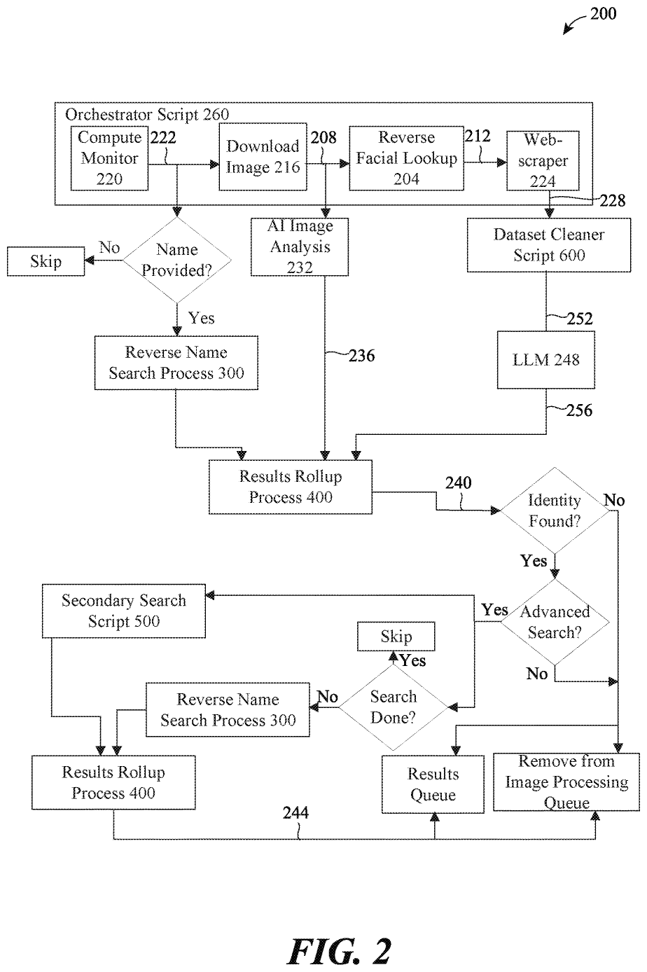

Referring now to FIG. 2, a flow diagram of an exemplary embodiment of a passive threat detection process 200 is shown. The Passive Threat Detection (PTD) process 200 may include an automated, multi-stage identity research workflow that may construct a structured personal profile of an individual from one or more identity inputs, such as a facial image and/or name. In some embodiments, beginning with facial recognition against indexed web content, passive threat detection process 200 may progressively gather, clean, and process data associated with the identified face and, where available, name. Passive threat detection process 200 may resolve this data into one or more comprehensive identity profiles that are returned to the requesting system upon completion.

With continued reference to FIG. 2, in some embodiments, passive threat detection process 200 may be organized into two tiers of operation. In a standard tier, in some embodiments, passive threat detection process 200 may perform facial recognition against indexed web content, scrape and clean the resulting source pages, extract structured identity fields using a language model, merge into or split those per-source extractions into one or more profiles, and return the result. In an advanced tier, in some embodiments, the standard tier workflow may be executed first, and its interim profile output may be then used to seed one or more additional enrichment stages, a secondary records search and/or an optional reverse name search. In passive threat detection process 200 a final results rollup may consolidate all collected data into a final output profile.

With continued reference to FIG. 2, in some embodiments, work items may enter and exit the pipeline using managed queues. As a non-limiting example, images awaiting processing may be held in image processing queue and completed profile results may be delivered to results queue. This queue-based architecture is a technical improvement because it decouples each processing stage from the others, allowing stages to operate at independent concurrency levels and enabling the pipeline to recover gracefully from transient failures without losing work.

With continued reference to FIG. 2, in some embodiments, passive threat detection process 200 may include a reverse facial lookup 204. Reverse facial lookup 204 may receive several input fields to initiate processing: key 116 (associated with the user-submitted image), a designated search tier that may determine the scope and priority of the detection pipeline (for example, this may be determined from the product choice of the user), an optional user-provided name, the User ID, and the like. In some embodiments, passive threat detection process 200 may receive all of the forgoing data, whereas reverse facial lookup 204 may only receive or use an image. These inputs may collectively parameterize the subsequent processing stages and establish the operational context for the passive threat detection process 200.

With continued reference to FIG. 2, reverse facial lookup process 204 may be performed on the image 208 to identify potential matches across various data sources. Reverse facial lookup 204 may include analyzing the facial features within image 208. Then reverse facial lookup 204 may include returning a set of candidate results 212.

With continued reference to FIG. 2, in some embodiments, passive threat detection process 200 may include a step of downloading the image 216. A compute monitor 220 may be configured to continuously monitor the availability of compute resources. This may include a step of downloading the image 216 from cloud-based storage. Cloud based storage may include S3 or AWS S3. When available resources are detected, compute monitor 220 may be configures to spawn a dedicated processing thread and poll the next pending job from image processing queue. This may represent a technical improvement as the polling mechanism may ensure that compute resources are allocated dynamically and that image processing tasks are dispatched in an orderly, queue-driven manner. Once a job is pulled from the queue, a retrieval operation may be initiated to perform the step of downloading the image 216 from cloud object storage (e.g. AWS S3); this may include job info 222.

With continued reference to FIG. 2, in some embodiments, performing reverse facial lookup 204 may include comparing the plurality of facial features to a plurality of candidate results. This may include comparing the plurality of facial features to a plurality of candidate results. In some embodiments, this may be done by calculating distance metrics between the facial features and the candidate results. Distance metrics may include, as non-limiting examples, Euclidian distance, Manhattan distance and/or cosine similarity. As a function of comparing the plurality of facial features to a plurality of candidate results, confidence scores for the candidate results may be determined. For example, larger distance metrics may be associated with lower confidence scores, whereas smaller distance metrics may be associated with higher confidence scores. In some embodiments, distance metrics for a plurality of attributes (or features) may be calculated and then averaged together to determine an average distance metric.

In some embodiments, performing a reverse facial lookup may include performing a reverse facial lookup using a reverse facial lookup API. For example, reverse facial lookup API may be queried and receive image 208. Reverse facial lookup API may return set of candidate results 212.

With continued reference to FIG. 2, in some embodiments, a subset of the candidate results 212 may be returned as a function of the confidence scores. In some embodiments, returned candidate results 212 may be filtered to remove entries that fall below a predefined confidence threshold. This may ensure that only sufficiently probable matches are retained for further processing. For example, set of candidate results 212 with a confidence score below a threshold may be excluded from the subset of set of candidate results 212.

With continued reference to FIG. 2, in some embodiments, returning the subset of the candidate results 212 as a function of the confidence scores may include receiving uniform resource locators (URLs) associated with the candidate results 212. In some embodiments, the URLs may be sent to a web scraper 224. Web scraper 224 may be configured to retrieve scraped data associated with the URLs. In this way, the resulting set of URLs may serve as input for downstream data extraction and analysis stages.

With continued reference to FIG. 2, web scraper 224 may be applied to the filtered set of URLs obtained from reverse facial lookup 204. The URLs may be first prioritized based on source quality metrics, which may include domain credibility, data relevance, and historical reliability. Following prioritization, in some embodiments, the top-ranked sources are accessed and parsed to extract relevant content associated with the identified individual. In some embodiments, if social media URLs are detected then individual web scrapers and/or API calls may be used to scrape data from social media site such as, as non-limiting examples, LINKEDIN, TWITTER (or X), INSTAGRAM, FACEBOOK, THREADS, BLUESKY, or the like. In some embodiments, the initial search may analyze the URLs and proceed to look for name, age, residency, occupation, warrants, and criminal records.

With continued reference to FIG. 2, web scraper 224 may also be known as a web-spider or web-robot, is an automated program or script designed to browse the internet systematically and collect data from websites. Web scraper 224 may start with a list of URLs and follow links on those pages to discover and index new content (for example, filtered set of URLs). The web scraper 224 may retrieve web pages, analyze their content, and store relevant information in a database or other data structure. Components of a web scraper 224 may include URL queue, a downloader, a parser, and storage. The URL queue is a list of URLs to visit, which may be dynamically updated as new links are discovered. The downloader is a component that retrieves web pages from the internet. A parser analyzes the content of the downloaded pages, extracting useful data and identifying new links. Further, storage may include a database and/or a file system where the scraped data may be stored for future retrieval and analysis. Web scraper 224 may output scraped content 228; in some embodiments, to a dataset cleaner script 600.

With continued reference to FIG. 2, passive threat detection process 200 may include an AI image analysis 232. In some embodiments, memory may include instructions configuring the processor to perform AI image analysis 232. AI image analysis 232 may include inputting the plurality of facial features into an image analysis model. Image analysis model may include a machine-learning model; for example, image analysis model may include a machine-learning model trained using machine-learning module 1200 of FIG. 12. Image analysis model may be trained using training data correlating, e.g., facial features to demographic characteristics. In some embodiments, image analysis model may be iteratively trained using a cost function in order to teach the model to accurately identify demographic characteristics based on the training data. The training process may involve iteratively updating one or more weights of the model as a function of the training. Performing AI image analysis 232 may include receiving an AI output 236 from the image analysis model. In some embodiments, AI output 236 may include a set of estimated demographic characteristics. Demographic characteristics may include, as non-limiting examples, age, race, gender, sex, and/or ethnicity.

Referring to FIG. 2, In some embodiments, AI output 236 may include an artificial generation likelihood score. This may include a qualitative or quantitative measure of the likelihood that the image is AI generated. In some embodiments, image analysis model may include a classifier, wherein the classifier is configured to classify the image or facial features to either “AI generated” or “not AI generated.” Classifier may be configured to output a confidence score associated with this classification. Classifier may include as non-limiting examples, linear discriminant analysis (LDA), k-nearest neighbors (KNN), Naïve Bayes, gaussian mixture model, and/or margin based classifiers. Classifier may be trained using classifier training data. Classification training data may include facial features or image data correlated to a classification associated with either being or not being AI generated. For example, classification training data may include exemplary inputs correlated to exemplary output classifications. Classifier may be trained using classification training data using, as non-limiting examples, an eager learning algorithm or a lazy learning algorithm.

In some embodiments, AI image analysis 232 may be conducted using an API. For example, inputs to AI image analysis 232 may be provided over API to an image analysis service. The image analysis service may conduct the analysis (e.g., remotely) and return the AI output 236.

In some embodiments, each attribute in AI output 236 may include a corresponding confidence score representing the model's certainty. These outputs may be retained and used as weighted inputs in subsequent analysis stages, enabling downstream processes to incorporate probabilistic reasoning and confidence-based filtering.

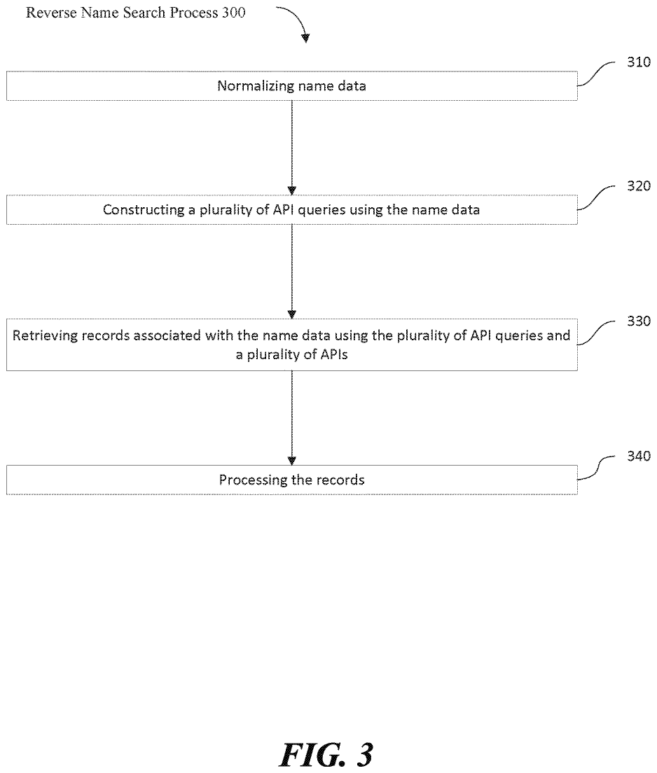

Referring to FIGS. 2 and 3, in some embodiments, passive threat detection process 200 may include a reverse name search 300. As a preliminary matter before initiating, reverse name search 300, passive threat detection process 200 may include determining or checking whether name data has been received from the user. If the name data has been received, then passive threat detection process 200 may include conducting reverse name search 300. If the name data has not been received, then reverse name search 300 may be skipped or omitted.

With continued reference to FIGS. 2 and 3, performing reverse name search 300 may include a step 310 of normalizing the name data. The system may begin by normalizing the user-provided name input. This may include standardizing formatting (e.g., capitalization, removal of extraneous characters, and handling of aliases or common variations) to ensure consistency and improve search accuracy across downstream services.

With continued reference to FIGS. 2 and 3, reverse name search 300 may include a step 320 of constructing a plurality of API queries using the name data. In some embodiments, once normalized, the name may be used to construct search queries that are executed across multiple data sources, including external APIs and web-based search endpoints. These queries are designed to retrieve relevant records associated with the provided name, such as public profiles, indexed pages, and database entries.

With continued reference to FIGS. 2 and 3, reverse name search 300 may include a step 330 of retrieving records associated with the name data using the plurality of API queries and a plurality of APIs. The system may aggregate responses from these sources for further processing.

With continued reference to FIGS. 2 and 3, reverse name search 300 may include a step 340 of processing the records. The returned data may then be processed through a parsing pipeline. Unstructured and semi-structured content may be analyzed to extract relevant attributes (e.g., associated identifiers, locations, affiliations). This information is converted into a structured format, enabling consistent storage and downstream analysis.

Data parsing and analysis as described throughout this disclosure may include natural language processing. As used in the current disclosure, a “natural language processing (NLP) model” is a computational model designed to process and understand human language. It leverages techniques from machine learning, linguistics, and computer science to enable computers to comprehend, interpret, and generate natural language text. The NLP model may preprocess the textual data, wherein the input text may include all text contained within the names or scraped data its associated metadata, or any other data mentioned herein. Preprocessing the input text may involve tasks like tokenization (splitting text into individual words or sub-word units), normalizing the text (lowercasing, removing punctuation, etc.), and encoding the text into a numerical representation suitable for the model. The NLP model may include transformer architecture, wherein the transformers are deep learning models that employ attention mechanisms to capture the relationships between words or sub-word units in a text sequence. They consist of multiple layers of self-attention and feed-forward neural networks. The NLP model may weigh the importance of different words or sub-word units within a text sequence while considering the context. It enables the model to capture dependencies and relationships between words, considering both local and global contexts. This process may be used to identify a plurality of named entities. Language processing model may include a program automatically generated by a processor and/or named entity recognition system to produce associations between one or more significant terms extracted from the names or scraped data its associated metadata and detect associations, including without limitation mathematical associations, between such significant terms. Associations between language elements, where language elements include for purposes herein extracted significant terms, relationships of such categories to other such term may include, without limitation, mathematical associations, including without limitation statistical correlations between any language element and any other language element and/or language elements. Statistical correlations and/or mathematical associations may include probabilistic formulas or relationships indicating, for instance, a likelihood that a given extracted significant term indicates a given category of semantic meaning. As a further example, statistical correlations and/or mathematical associations may include probabilistic formulas or relationships indicating a positive and/or negative association between at least an extracted significant term and/or a given semantic relationship; positive or negative indication may include an indication that a given document is or is not indicating a category semantic relationship. Whether a phrase, sentence, word, or other textual element in the names or scraped data its associated metadata constitutes a positive or negative indicator may be determined, in an embodiment, by mathematical associations between detected significant terms, comparisons to phrases and/or words indicating positive and/or negative indicators that are stored in memory at a processor, or the like.

### Results Rollup

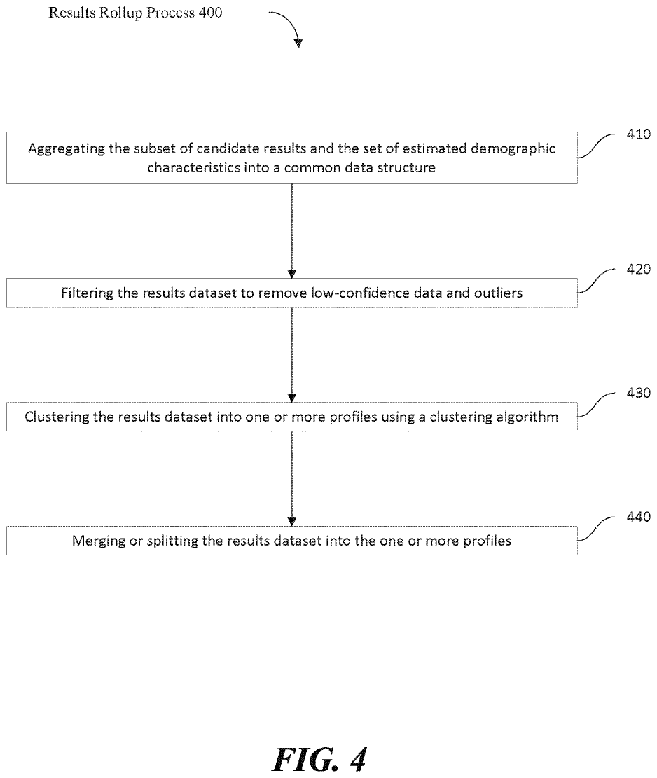

Referring now to FIGS. 2 and 4, passive threat detection process 200 may include a results rollup process 400. Process 400 may include consolidating and refining data collected from prior search processes into coherent identity profiles through a multi-stage aggregation and validation pipeline.

With continued reference to FIGS. 2 and 4, process 400 may include a step 410 of aggregate the subset of candidate results and the set of estimated demographic characteristics into a results dataset. Results dataset may include a common data structure that consolidates the info from upstream data processes. Extracted data may be aggregated into a tabular structure, aligning fields across multiple sources. Duplicate records may be identified and removed, while overlapping data points are cross-referenced to validate consistency and improve data reliability. Duplicating and overlapping data may be identified be calculating distance metrics between the data embeddings and removing duplicate sets of data lower distance metrics.

With continued reference to FIGS. 2 and 4, process 400 may include a step 420 of filtering the results dataset to remove low-confidence data and outliers. In some embodiments, outlier analysis may include statistical analysis to determine outliers. In some embodiments, “low-confidence” data may be identified using confidence scores as calculated by upstream processes. In some embodiments, the system may apply scoring mechanisms to evaluate the confidence of each data point. Entries that fall below defined confidence thresholds, or that significantly deviate from consensus patterns across sources, may be filtered out to reduce noise and improve overall accuracy.

With continued reference to FIGS. 2 and 4, process 400 may include a step 430 of clustering the results dataset into one or more profiles using a clustering algorithm. The data may be grouped based on identity signals using field-level similarity (e.g., name, location, affiliations). Clustering algorithms may assess coherence across attributes to determine which data points likely correspond to the same individual. Clustering algorithms may include, as non-limiting examples, means clustering, hierarchical clustering, DBSCAN (Density-Based Spatial Clustering of Applications with Noise), Gaussian Mixture Models (GMMs), and Spectral Clustering.

With continued reference to FIGS. 2 and 4, process 400 may include a step 440 of merging or splitting the results dataset into the one or more profiles 240. Based on clustering results, the process resolves whether data should be merged into a single unified profile or separated into multiple distinct profiles. This step ensures accurate representation of one or more identities, minimizing false associations. This step may include classification algorithms as described above.

### Advanced Search

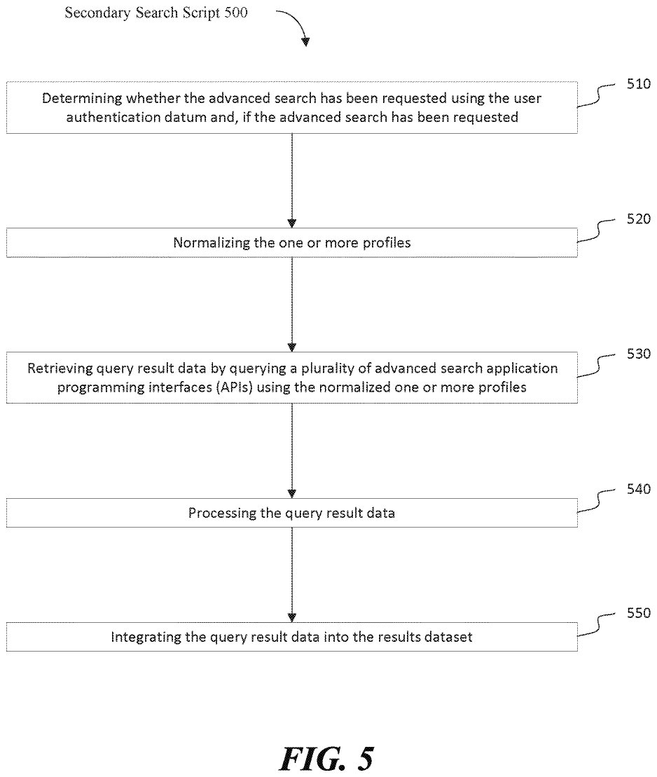

Referring to FIGS. 2 and 5, if an identity has been successfully identified during the Base Search process (e.g., based on one or more profiles 240), and if the user has selected the advanced search tier, then the system may initiate the secondary search script 500. Otherwise, this process is skipped. Secondary search script 500 may include a step 510 of determining whether the advanced search has been requested using the user authentication datum and, if the advanced search has been requested.

With continued reference to FIGS. 2 and 5, secondary search script 500 may include a step 520 of normalizing the one or more profiles. In some embodiments, step 520 may include using a query builder. The query builder may normalize the identified profile associated with the resolved identity by extracting key attributes. This process may include actions such as resolving known variations and structuring the data into a standardized format suitable for expanded query generation. This may take as input the Name, Age, and residency from initial search.

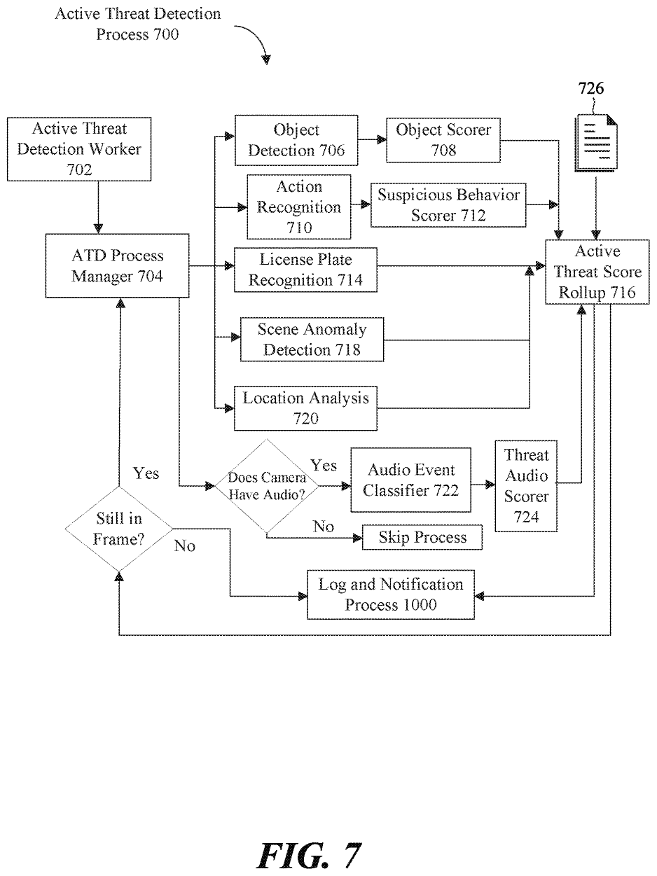

With continued reference to FIGS. 2 and 5, secondary search script 500 may include a step 530 of retrieving query result data by querying a plurality of advanced search application programming interfaces (APIs). In some embodiments, this may include using the normalized profiles. APIs are further described with reference to FIG. 7. APIs may include, as non-limiting examples, any of the APIs described with reference to FIG. 7. In some embodiments, using the found identity, the system may execute additional queries across an extended set of data sources, including premium APIs, deeper web indexes, and specialized databases. These queries may be designed to retrieve more comprehensive and higher-confidence data associated with the identified individual. In some embodiments, this may include, querying other databases to find and verify more information on the person. In certain aspects, the secondary search includes sex offender registry's, criminal databases, and the like.

With continued reference to FIGS. 2 and 5, secondary search script 500 may include a step 540 of processing the query results. Processing the query results may include receiving results from the APIs as described above.

With continued reference to FIGS. 2 and 5, secondary search script 500 may include a step 550 of integrating the query result data into the results dataset. In some embodiments the returned data may be processed through a structured extraction pipeline. Scraping and parsing mechanisms may analyze both structured and unstructured content to extract relevant attributes (e.g., affiliations, historical records, associated entities, etc.). The extracted data is normalized and formatted for integration with previously collected results.

With continued reference to FIGS. 2 and 5, if a Reverse Name Search 300 has not already been executed, and if the advanced search tier was selected, then the system may initiate reverse name search 300 process at this stage. Otherwise, the reverse name search 300 is skipped to prevent redundant operations. This conditional execution represents a technical improvement as it ensures that all available identity-linked data pathways are explored while maintaining system efficiency by avoiding duplicate searches. This improves computational efficiency and allows for more efficient use of computational resources.

With continued reference to FIGS. 2 and 5, if the advanced search tier was selected, an additional Results Rollup 400 execution is performed after all enrichment stages have completed. This step may retrieve the interim profile or profiles produced by the standard-tier results rollup, the structured records returned by the secondary search script 500, and, where a candidate name was available and reverse name search 300 was executed, the results of that reverse name search 300. These three data sets may be merged into a single expanded input corpus and passed through the same Results Rollup 400 logic. Because process 400 and reverse name search 300 sources are typically higher in structured data density than the facial-recognition-sourced web pages processed in the standard tier (e.g., returning records such as address histories, court filings, and public registry entries), this second rollup pass frequently resolves ambiguities that the first pass could not, and produces profiles with materially higher field completeness and confidence scores. Therefore, this unique dual stage rollup process represents a technical improvement in the field of data processing. The output of this step may include one or more updated profile objects (e.g., final results 244) that may supersede the interim profiles produced previously.

### Data Cleaner Script

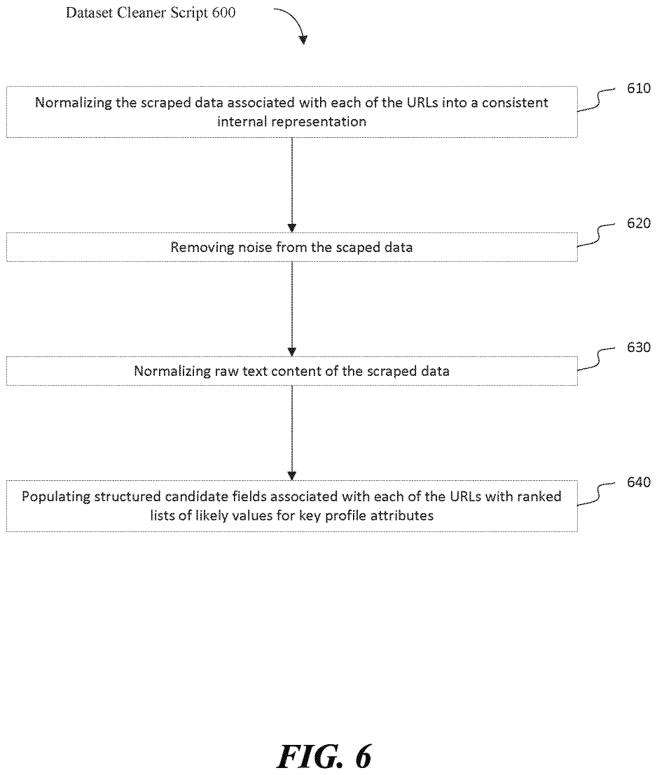

Referring now to FIGS. 2 and 6, passive threat detection process 200 may include a data cleaner script 600. In some embodiments, dataset cleaner script 600 may receive scraped content 228 from web scraper 224. In some embodiments, dataset cleaner script 600 may clean the scraped content 228 from web scraper 224.

With continued reference to FIGS. 2 and 6, dataset cleaner script 600 may include a step 610 of normalizing the scraped data associated with each of the URLs into a consistent internal representation. Raw data may be ingested from a JSON file produced by the web scraper 224. The dataset cleaner script 600 may support multiple input format variants, detecting the structure at runtime and normalizing each page payload into a consistent internal representation. For each page, a priority-ordered probe may select the best available text field. Metadata fields (title, author, description, published date, etc.) may be extracted from a structured allowlist and normalized using, as a non-limiting example, a script such as Python's urllib.parse and datetime libraries. Published dates may be resolved through a four-layer fallback hierarchy: structured metadata fields, date patterns extracted from the URL path, date patterns extracted from the raw text body, and date patterns extracted from the page title.

With continued reference to FIGS. 2 and 6, dataset cleaner script 600 may include a step 620 of removing noise from the scraped content 228. In some embodiments, dataset cleaner script 600 may include a step 630 of normalizing raw text content of the scraped data. For example, in some embodiments, the raw text may undergo a multi-step cleaning pipeline. Markdown formatting may be stripped to plain text. Unicode punctuation may be normalized to ASCII equivalents. Boilerplate content (including, as non-limiting examples, navigation text, cookie consent blocks, subscription prompts, social sharing elements, and legal/policy language) may be identified and removed using curated keyword lists and regex-based pattern matching (as non-limiting examples (“search,” “please subscribe,” TWITTER sharing buttons, and the like). Duplicate and near-duplicate content blocks may be identified and suppressed using MD5 hashing. Long paragraphs may be segmented into coherent chunks using sentence-boundary detection and a discourse-pivot heuristic that identifies natural topic transitions. Content following feed or footer markers (e.g., “Related Articles”, “You May Also Like”) may be truncated. This may include the use of natural language processing.

With continued reference to FIGS. 2 and 6, dataset cleaner script 600 may include a step 640 of populating structured candidate fields associated with each of the URLs with ranked lists of likely values for key profile attributes. From the cleaned text, the script may populate structured candidate fields for each source page. These fields may serve as pre-computed identity signals passed to the downstream LLM extraction stage; for example, providing ranked lists of likely values for key profile attributes so the model can evaluate and select from plausible candidates rather than extracting from scratch. Each candidate value may carry an associated confidence score reflecting the strength of the contextual evidence supporting it. These fields may include but are not limited to: a facts-only list, which extracts high-signal sentences using length filters, a fact-signal gate (as non-limiting examples, requiring legal/news verbs, named entities, or temporal markers), and deduplication. Person name candidates, which may be scored from multiple sources (as non-limiting examples, URL slugs, page title, body text frequency, co-occurrence with age expressions, and alias patterns) then may be filtered through a cascading rejection chain that removes, as non-limiting examples, location strings, organizational entities, job title phrases, and names lacking identity-context support. Age and date-of-birth candidates, which may be extracted using various regex patterns covering common age expression formats, where a parse-able DOB is found, a derived integer age may be computed relative to the page's published date. Location candidates, which may be extracted through precision tiers ranging from explicitly labeled fields (“Location: City, ST”) down to preposition-introduced place names, with filtering to prevent person names and common non-place words from being misclassified as locations.

Referring to FIG. 2, a large language model (LLM) 248 may receive cleaned scraped data 252 from dataset cleaner script 600. LLM 248 may process the aggregated and cleaned data collected from prior stages. Each source-specific dataset may be independently analyzed to identify and extract structured profile attributes associated with the subject, producing a distinct profile output per input source. Passive threat detection process 200 may include inputting each set of cleaned scraped data into LLM 248. In some embodiments, passive threat detection process 200 may include generating, using LLM 248, structured profile attributes 256 associated with a subject. Extracted attributes may include, but are not limited to, name, age, occupation, affiliated organizations, educational background, geographic location, criminal records, and publicly available records. The LLM 248 may be configured to normalize and organize this information into a consistent profile representation, enabling downstream aggregation, comparison, and analysis across multiple sources. For example, LLM 248 may be prompted with “based on [cleaned scraped data 252], please identify the attributes including, name, age, occupation, affiliated organizations, educational background, geographic location, criminal records, and publicly available records.”

With continued reference to FIG. 2, LLM 248 may include an instruction-tuned transformer model. Instruction-tuned transformer model may be fine-tuned on examples of: Instruction/Prompt: “extract attributes” and Desired Response: [structured profile attributes 256]. In some embodiments, each inputted set of cleaned scraped data 252 may be provided to the LLM as a structured JavaScript Object Notation (JSON) file. In some embodiments, the instruction-tuned transformer model may be constrained to produce strictly formatted JSON outputs with predefined fields. This provides a technical benefit of, ensuring consistency and compatibility with downstream processing components. In one embodiment, LLM 248 may utilize an instruction-tuned transformer model, such as, as a non-limiting example, Mistral-7B-Instruct-v0.1. Input may be provided as structured JSON generated during prior web scraping and preprocessing stages, allowing for efficient parsing and context-aware extraction. The model is constrained to produce strictly formatted JSON outputs with predefined fields, ensuring consistency and compatibility with downstream processing components.

With continued reference to FIG. 2, a “large language model,” or “LLM,” as used herein, is a deep learning data structure that can recognize, summarize, translate, predict and/or generate text and other content based on knowledge gained from massive datasets. Large language models may be trained on large sets of data. Training sets may be drawn from diverse sets of data such as, as non-limiting examples, novels, blog posts, articles, emails, unstructured data, electronic records, and the like. In some embodiments, training sets may include a variety of subject matters, such as, as nonlimiting examples, academic report documents, entity documents, business documents, inventory documentation, emails, user communications, advertising documents, newspaper articles, and the like. In some embodiments, training sets of an LLM may include information from one or more public or private databases. As a non-limiting example, training sets may include databases associated with an entity. In some embodiments, training sets may include portions of documents associated with the electronic records correlated to examples of outputs. In an embodiment, an LLM may include one or more architectures based on capability requirements of an LLM. Exemplary architectures may include, without limitation, GPT (Generative Pretrained Transformer), BERT (Bidirectional Encoder Representations from Transformers), T5 (Text-To-Text Transfer Transformer), and the like. Architecture choice may depend on a needed capability such generative, contextual, or other specific capabilities.

With continued reference to FIG. 2, in some embodiments, an LLM may be generally trained. As used in this disclosure, a “generally trained” LLM is an LLM that is trained on a general training set comprising a variety of subject matters, data sets, and fields. In some embodiments, an LLM may be initially generally trained. Additionally, or alternatively, an LLM may be specifically trained. As used in this disclosure, a “specifically trained” LLM is an LLM that is trained on a specific training set, wherein the specific training set includes data including specific correlations for the LLM to learn. For example, LLM may be specifically trained on the ASIC framework as described throughout this disclosure. As a non-limiting example, an LLM may be generally trained on a general training set, then specifically trained on a specific training set. In an embodiment, specific training of an LLM may be performed using a supervised machine learning process. In some embodiments, generally training an LLM may be performed using an unsupervised machine learning process. As a non-limiting example, specific training set may include information from a database. As a non-limiting example, specific training set may include text related to the users such as user specific data for electronic records correlated to examples of outputs. In an embodiment, training one or more machine learning models may include setting the parameters of the one or more models (weights and biases) either randomly or using a pretrained model. Generally training one or more machine learning models on a large corpus of text data can provide a starting point for fine-tuning on a specific task. A model such as an LLM may learn by adjusting its parameters during the training process to minimize a defined loss function, which measures the difference between predicted outputs and ground truth. Once a model has been generally trained, the model may then be specifically trained to fine-tune the pretrained model on task-specific data to adapt it to the target task. Fine-tuning may involve training a model with task-specific training data, adjusting the model's weights to optimize performance for the particular task. In some cases, this may include optimizing the model's performance by fine-tuning hyperparameters such as learning rate, batch size, and regularization. Hyperparameter tuning may help in achieving the best performance and convergence during training. In an embodiment, fine-tuning a pretrained model such as an LLM may include fine-tuning the pretrained model using Low-Rank Adaptation (LoRA). As used in this disclosure, “Low-Rank Adaptation” is a training technique for large language models that modifies a subset of parameters in the model. Low-Rank Adaptation may be configured to make the training process more computationally efficient by avoiding a need to train an entire model from scratch. In an exemplary embodiment, a subset of parameters that are updated may include parameters that are associated with a specific task or domain.

With continued reference to FIG. 2, in some embodiments an LLM may include and/or be produced using Generative Pretrained Transformer (GPT), GPT-2, GPT-3, GPT-4, and the like. GPT, GPT-2, GPT-3, GPT-3.5, and GPT-4 are products of Open AI Inc., of San Francisco, CA.

Still referring to FIG. 2, an LLM may include a transformer architecture. In some embodiments, encoder component of an LLM may include transformer architecture. A “transformer architecture,” for the purposes of this disclosure is a neural network architecture that uses self-attention and positional encoding. Transformer architecture may be designed to process sequential input data, such as natural language, with applications towards tasks such as translation and text summarization. Transformer architecture may process the entire input all at once. “Positional encoding,” for the purposes of this disclosure, refers to a data processing technique that encodes the location or position of an entity in a sequence. In some embodiments, each position in the sequence may be assigned a unique representation. In some embodiments, positional encoding may include mapping each position in the sequence to a position vector. In some embodiments, trigonometric functions, such as sine and cosine, may be used to determine the values in the position vector. In some embodiments, position vectors for a plurality of positions in a sequence may be assembled into a position matrix, wherein each row of position matrix may represent a position in the sequence.

With continued reference to FIG. 2, an LLM and/or transformer architecture may include an attention mechanism. An “attention mechanism,” as used herein, is a part of a neural architecture that enables a system to dynamically quantify the relevant features of the input data. In the case of natural language processing, input data may be a sequence of textual elements. It may be applied directly to the raw input or to its higher-level representation.

With continued reference to FIG. 2, attention mechanism may represent an improvement over a limitation of an encoder-decoder model. An encoder-decider model encodes an input sequence to one fixed length vector from which the output is decoded at each time step. This issue may be seen as a problem when decoding long sequences because it may make it difficult for the neural network to cope with long sentences, such as those that are longer than the sentences in the training corpus. Applying an attention mechanism, an LLM may predict the next word by searching for a set of positions in a source sentence where the most relevant information is concentrated. An LLM may then predict the next word based on context vectors associated with these source positions and all the previously generated target words, such as textual data of a dictionary correlated to a prompt in a training data set. A “context vector,” as used herein, are fixed-length vector representations useful for document retrieval and word sense disambiguation.

Still referring to FIG. 2, attention mechanism may include, without limitation, generalized attention self-attention, multi-head attention, additive attention, global attention, and the like. In generalized attention, when a sequence of words or an image is fed to an LLM, it may verify each element of the input sequence and compare it against the output sequence. Each iteration may involve the mechanism's encoder capturing the input sequence and comparing it with each element of the decoder's sequence. From the comparison scores, the mechanism may then select the words or parts of the image that it needs to pay attention to. In self-attention, an LLM may pick up particular parts at different positions in the input sequence and over time compute an initial composition of the output sequence. In multi-head attention, an LLM may include a transformer model of an attention mechanism. Attention mechanisms, as described above, may provide context for any position in the input sequence. For example, if the input data is a natural language sentence, the transformer does not have to process one word at a time. In multi-head attention, computations by an LLM may be repeated over several iterations, each computation may form parallel layers known as attention heads. Each separate head may independently pass the input sequence and corresponding output sequence element through a separate head. A final attention score may be produced by combining attention scores at each head so that every nuance of the input sequence is taken into consideration. In additive attention (Bahdanau attention mechanism), an LLM may make use of attention alignment scores based on a number of factors. Alignment scores may be calculated at different points in a neural network, and/or at different stages represented by discrete neural networks. Source or input sequence words are correlated with target or output sequence words but not to an exact degree. This correlation may take into account all hidden states and the final alignment score is the summation of the matrix of alignment scores. In global attention (Luong mechanism), in situations where neural machine translations are required, an LLM may either attend to all source words or predict the target sentence, thereby attending to a smaller subset of words.

With continued reference to FIG. 2, multi-headed attention in encoder may apply a specific attention mechanism called self-attention. Self-attention allows models such as an LLM or components thereof to associate each word in the input, to other words. As a non-limiting example, an LLM may learn to associate the word “you,” with “how” and “are.” It's also possible that an LLM learns that words structured in this pattern are typically a question and to respond appropriately. In some embodiments, to achieve self-attention, input may be fed into three distinct fully connected neural network layers to create query, key, and value vectors. A query vector may include an entity's learned representation for comparison to determine attention score. A key vector may include an entity's learned representation for determining the entity's relevance and attention weight. A value vector may include data used to generate output representations. Query, key, and value vectors may be fed through a linear layer; then, the query and key vectors may be multiplied using dot product matrix multiplication in order to produce a score matrix. The score matrix may determine the amount of focus for a word should be put on other words (thus, each word may be a score that corresponds to other words in the time-step). The values in score matrix may be scaled down. As a non-limiting example, score matrix may be divided by the square root of the dimension of the query and key vectors. In some embodiments, the softmax of the scaled scores in score matrix may be taken. The output of this softmax function may be called the attention weights. Attention weights may be multiplied by your value vector to obtain an output vector. The output vector may then be fed through a final linear layer.

Still referencing FIG. 2, in order to use self-attention in a multi-headed attention computation, query, key, and value may be split into N vectors before applying self-attention. Each self-attention process may be called a “head.” Each head may produce an output vector and each output vector from each head may be concatenated into a single vector. This single vector may then be fed through the final linear layer discussed above. In theory, each head can learn something different from the input, therefore giving the encoder model more representation power.

With continued reference to FIG. 2, encoder of transformer may include a residual connection. Residual connection may include adding the output from multi-headed attention to the positional input embedding. In some embodiments, the output from residual connection may go through a layer normalization. In some embodiments, the normalized residual output may be projected through a pointwise feed-forward network for further processing. The pointwise feed-forward network may include a couple of linear layers with a ReLU activation in between. The output may then be added to the input of the pointwise feed-forward network and further normalized.

Continuing to refer to FIG. 2, transformer architecture may include a decoder. Decoder may a multi-headed attention layer, a pointwise feed-forward layer, one or more residual connections, and layer normalization (particularly after each sub-layer), as discussed in more detail above. In some embodiments, decoder may include two multi-headed attention layers. In some embodiments, decoder may be autoregressive. For the purposes of this disclosure, “autoregressive” means that the decoder takes in a list of previous outputs as inputs along with encoder outputs containing attention information from the input.

With further reference to FIG. 2, in some embodiments, input to decoder may go through an embedding layer and positional encoding layer in order to obtain positional embeddings. Decoder may include a first multi-headed attention layer, wherein the first multi-headed attention layer may receive positional embeddings.

With continued reference to FIG. 2, first multi-headed attention layer may be configured to not condition to future tokens. As a non-limiting example, when computing attention scores on the word “am,” decoder should not have access to the word “fine” in “I am fine,” because that word is a future word that was generated after. The word “am” should only have access to itself and the words before it. In some embodiments, this may be accomplished by implementing a look-ahead mask. Look ahead mask is a matrix of the same dimensions as the scaled attention score matrix that is filled with “0s” and negative infinities. For example, the top right triangle portion of look-ahead mask may be filled with negative infinities. Look-ahead mask may be added to scaled attention score matrix to obtain a masked score matrix. Masked score matrix may include scaled attention scores in the lower-left triangle of the matrix and negative infinities in the upper-right triangle of the matrix. Then, when the softmax of this matrix is taken, the negative infinities will be zeroed out; this leaves zero attention scores for “future tokens.”

Still referring to FIG. 2, second multi-headed attention layer may use encoder outputs as queries and keys and the outputs from the first multi-headed attention layer as values. This process matches the encoder's input to the decoder's input, allowing the decoder to decide which encoder input is relevant to put a focus on. The output from second multi-headed attention layer may be fed through a pointwise feedforward layer for further processing.

With continued reference to FIG. 2, the output of the pointwise feedforward layer may be fed through a final linear layer. This final linear layer may act as a classifier. This classifier may be as big as the number of classes that you have. For example, if you have 10,000 classes for 10,000 words, the output of that classifier will be of size 10,000. The output of this classifier may be fed into a softmax layer which may serve to produce probability scores between zero and one. The index may be taken of the highest probability score in order to determine a predicted word.

Still referring to FIG. 2, decoder may take this output and add it to the decoder inputs. Decoder may continue decoding until a token is predicted. Decoder may stop decoding once it predicts an end token.

Continuing to refer to FIG. 2, in some embodiment, decoder may be stacked N layers high, with each layer taking in inputs from the encoder and layers before it. Stacking layers may allow an LLM to learn to extract and focus on different combinations of attention from its attention heads.

With continued reference to FIG. 2, an LLM may receive an input. Input may include a string of one or more characters. Inputs may additionally include unstructured data. For example, input may include one or more words, a sentence, a paragraph, a thought, a query, and the like. A “query” for the purposes of the disclosure is a string of characters that poses a question. In some embodiments, input may be received from a user device. User device may be any computing device that is used by a user. As non-limiting examples, user device may include desktops, laptops, smartphones, tablets, and the like.

With continued reference to FIG. 2, an LLM may generate at least one annotation as an output. At least one annotation may be any annotation as described herein. In some embodiments, an LLM may include multiple sets of transformer architecture as described above. Output may include a textual output. A “textual output,” for the purposes of this disclosure is an output comprising a string of one or more characters. Textual output may include, for example, a plurality of annotations for unstructured data. In some embodiments, textual output may include a phrase or sentence identifying the status of a user query. In some embodiments, textual output may include a sentence or plurality of sentences describing a response to a user query. As a non-limiting example, this may include restrictions, timing, advice, dangers, benefits, and the like.

With continued reference to FIG. 2, in some embodiments, orchestrator script 260 may include compute monitor 220, downloading image 216, reverse facial lookup 204, and/or web scraper 224.

With continued reference to FIG. 2, in some embodiments, final results 244 may be sent to a results queue. Results queue may a data queue. In some embodiments, results queue may include an AWS SQS queue. Results queue may be referred to as “Q_Results.” Results queue may be used to store completed analysis results pending delivery to the user. Results queue may contain messages representing finalized outputs generated by the Passive Threat Detection process that have not yet been transmitted to client-facing delivery mechanisms. In some embodiments, each message may include the resulting data set, along with associated metadata such as the user ID, transaction ID, and any relevant processing context. Results queue may enable asynchronous handling of result delivery, ensuring separation between compute-intensive analysis and user notification workflows.

Referring back to FIG. 1, after passive threat detection process 200, the output of passive threat detection process 200 may be fed through passive threat score rollup 124. In some embodiments, passive threat detection process 200 may output a structured profile associated with an identified individual, including attributes such as name, age, location, employment information, criminal history, offender registry data, and the like. The passive threat score rollup 124 may ingest this profile data and compute a composite threat score based on a plurality of contributing factors. Passive threat score rollup 124 may also consume user-configured threat preferences including, as non-limiting examples, per-stream sensitivity thresholds, per-class alert weights, suppression rules for specific contexts, and overall alert sensitivity level. This configuration may be supplied at pipeline initialization and allows the system to be tuned to the specific risk profile of a deployment. The resulting profile data and associated metadata may then be saved to database 126, in some embodiments indexed by the individual's unique ID, allowing the system to reference their information in future encounters. The resulting profile data may also be fed to Log and Notification process 1000.

### Active Threat Detection Process

With continued reference to FIG. 1, layered surveillance system 100 may be configured to perform an active threat detection process 700. In some embodiments, active threat detection process 700 may receive enriched stamped frames including, as non-limiting examples, tracking ID (per-camera), bounding box, appearance embedding, and/or track age (frames since first detection).

Referring now to FIG. 7, a flow diagram of an exemplary embodiment of active threat detection process 700. The active threat detection process 700 is layered surveillance system 100's real-time behavioral and contextual threat analysis pipeline. Active threat detection process 700 may include an automated, multi-stream evaluation workflow that assesses enriched Stamped Frame data for indicators of potential threat across multiple independent analytical dimensions. Receiving its inputs from shared analysis pools, active threat detection process 700 may route each Stamped Frame through a set of parallel detection streams, each focused on a distinct threat vector, before consolidating their outputs into a unified threat score that drives suppress-or-escalate decisions and any resulting alerts or downstream actions.

With continued reference to FIG. 7, active threat detection (ATD) process 700 may be organized around parallel stream execution followed by a single consolidation stage. In some embodiments, each detection stream operates independently, analyzing the Stamped Frame data through its designated lens and producing a weighted sub-score reflecting its assessed threat contribution. Upon completion of all streams, a weighted rollup stage may aggregate the individual stream outputs into a single composite threat score. That score is then evaluated against defined thresholds to determine the appropriate system response, whether suppression of the event or escalation through alerting and action triggers.

With continued reference to FIG. 7, all work items may enter the pipeline through a managed queue. Stamped Frames awaiting threat evaluation may be in the inbound analysis queue; upon completion, the composite threat score and associated evaluation data may be written to a log. A separate downstream process may monitor that log and is responsible for determining the appropriate system response. This queue-based input architecture may decouple each detection stream from the others and from the consolidation stage, allowing each component to operate at independent concurrency levels and enabling the pipeline to recover gracefully from transient failures without loss of work. The log-based output architecture may decouple the ATD process from downstream consumers, allowing multiple concurrent processes (such as safety detection, facial recognition, and other analytical subsystems) to independently read from and act upon the threat log without direct coupling to the ATD pipeline itself.

With continued reference to FIG. 7, active threat detection process 700 may include an active threat detection worker 702. The active threat detection worker 702 may serve as the entry point of active threat detection process 700. Active threat detection worker 702 may ingest incoming Stamped Frame data from the inbound analysis queue and forward it to an ATD Process Manager 704 for analysis.

With continued reference to FIG. 7, ATD Process Manager 704 may be responsible for orchestrating the execution of all active detection streams within active threat detection process 700. Upon receiving a Stamped Frame, ATD Process Manager 704 may dispatch it to all active detection streams simultaneously and owns the threat event lifecycle, tracking which tracking IDs have active threat assessments in progress. To support detection of time-extended behaviors (as a non-limiting example, things that cannot be identified from any single frame), ATD Process Manager 704 maintains a shared temporal context store. Shared temporal context store may include, as a non-limiting example, a rolling time-window history of all track events, which may be keyed by tracking ID. Shared temporal context store may be accessible to all detection stream analyzers and may enable the identification of sustained or progressive behavioral patterns (such as loitering, following, circling, etc.) that only become apparent when evaluated across multiple frames over time.

With continued reference to FIG. 7, active threat detection process 700 may include an active detection stream for object and concealment detection. Object and concealment detection may include an object detection 706 algorithm. Object detection 706 algorithm may include a YOLO-based object detection model. Object detection 706 algorithm may be configured and trained to recognize threat-specific object classes, including but not limited to firearms, bladed weapons, blunt instruments, and associated paraphernalia indicative of potential harmful intent. Object detection 706 algorithm may be trained using object detection training data correlating exemplary bounding boxes and frames to treat-specific object classes. Rather than operating on the entirety of an input image frame, Object detection 706 algorithm may be selectively applied to a dynamically generated subregion corresponding to a bounding box of a previously detected person. This bounding box is produced by an upstream person detection and tracking process and represents the spatial extent of the individual within the scene. By restricting inference to this cropped region of interest, the system may significantly reduce computational overhead, enabling faster processing and improved scalability across multiple concurrent video streams. Additionally, this targeted approach may reduce the likelihood of false positive detections by eliminating irrelevant background regions and focusing the model's attention on areas most likely to contain threat-related objects, particularly those in proximity to or being carried by the detected individual. In certain implementations, the cropped region may be expanded by a configurable margin to include nearby contextual information before it is fed into object detection 706 algorithm, such as objects held slightly outside the primary bounding box.

With continued reference to FIG. 7, object detection 706 algorithm may be configured to, using a concealment classification model operating in parallel with the object detection algorithm, identify visual indicators associated with identity concealment. In parallel with the object detection process, a secondary lightweight classification model may be executed on the same cropped region. This concealment classification model may be optimized for efficiency and is trained to identify visual indicators associated with identity concealment. Such indicators include, but are not limited to, balaclavas, masks, hoods, scarves, and other facial obstructions that partially or fully obscure identifiable facial features. The concealment classification model may operate using either a single-frame inference approach or a short temporal aggregation of frames to improve robustness under varying lighting and motion conditions.

With continued reference to FIG. 7, output from object detection 706 may be fed to object scorer 708. This scorer 708 may be configured to evaluate outputs from the object and concealment detection stream in conjunction with track history data from a temporal context store. The temporal context store may maintain historical detection data for each tracked entity, including previously detected object classes, confidence scores, and concealment indicators, enabling the module to assess threat relevance over time rather than on a single-frame basis. The scoring process may incorporate both the type of detected object and its associated confidence level, as well as temporal characteristics such as persistence and recurrence across frames. Object classes may be assigned baseline severity weights, which may be scaled using detection confidence and/or adjusted based on temporal consistency. As a non-limiting example, a single low-confidence detection of a potential weapon may contribute minimally to the score, whereas repeated high-confidence detections across consecutive frames may result in a significantly elevated threat score. In parallel, scorer 708 may evaluate outputs from the concealment classifier to determine whether the tracked entity exhibits indicators of identity concealment. The presence of concealment may be assessed with consideration of temporal persistence, such that consistent detection across multiple frames strengthens the reliability of the concealment determination. Based on this evaluation, scorer 708 may generate a concealment flag. The concealment flag may function as a contextual modifier applied to other analytical outputs, increasing the weighting or severity of independently derived threat signals. As a non-limiting example, the presence of identity concealment may amplify the impact of detected objects or suspicious behaviors, reflecting an increased overall risk profile when multiple indicators co-occur. Scorer 708 may output a weapon threat score representing the assessed risk associated with detected objects, along with the concealment flag. These outputs may be continuously updated as new detection data is received and are provided to downstream components for integration into a comprehensive threat assessment framework.

With continued reference to FIG. 7, active threat detection process 700 may include an active detection stream for action recognition. Active threat detection process 700 may include an action recognition algorithm 710. Action recognition algorithm 710 may be trained on a set of behavior classes pertaining to threat assessment. Action recognition algorithm 710 may be configured to receive a sequence of the plurality of frames as input and output a suspicious behavior score. Action recognition algorithm 710 may be configured to analyze temporal sequences of image frames to classify behaviors exhibited by tracked entities, including individuals and vehicles, within a monitored environment. Action recognition algorithm 710 may receive, as input, a sequence of frames associated with a persistent tracking ID generated by an upstream tracking system, thereby enabling consistent observation of a single entity across time. This temporal input may allow the model to capture motion patterns, trajectory information, and contextual changes that are not discernible from individual frames in isolation. Action recognition algorithm 710 may be trained on a set of behavior classes specifically selected for threat assessment and security applications. These classes may include, but are not limited to, loitering, following or tailing another individual, repeated traversal or circling of a defined perimeter, aggressive or confrontational posturing, and rapid movement such as running. In some implementations, additional contextual features (such as proximity to restricted areas, interaction with other tracked entities, or deviations from typical movement patterns) may be incorporated into the classification process to improve accuracy and relevance. Unlike conventional object detection models that operate on single frames, in some embodiments, action recognition algorithm 710 may process a defined temporal window comprising multiple consecutive frames. This window may be implemented as a fixed-length sequence or a sliding window that continuously updates as new frames are received. By aggregating information over time, action recognition algorithm 710 may be able to distinguish between transient, nonthreatening movements and sustained or patterned behaviors indicative of potential risk. For example, brief stationary behavior may be classified differently from prolonged loitering, and incidental proximity to another individual may be distinguished from intentional following. Action recognition algorithm 710 may utilize architectures designed for spatiotemporal analysis, including but not limited to 3D convolutional neural networks (3D CNNs), recurrent neural networks (RNNs), long short-term memory (LSTM) networks, temporal convolutional networks (TCNs), or transformer-based sequence models. In certain implementations, the model may also incorporate optical flow, pose estimation data, or trajectory embeddings to enhance sensitivity to motion dynamics and behavioral cues. The output of the action recognition process may include one or more behavior classifications associated with each tracked entity, along with corresponding confidence scores. These outputs may be aligned with the tracking system and may be updated continuously as new frames are processed, enabling real-time or near-real-time behavioral assessment.

With continued reference to FIG. 7, action recognition algorithm 710 may feed into or include a suspicious behavior scorer 712. Suspicious behavior scorer 712 may be configured to evaluate outputs from action recognition algorithm 710 in conjunction with track history data obtained from a temporal context store and the duration of identified behaviors. The temporal context store may maintain historical information for each tracked entity, including prior classifications, movement trajectories, and timestamps, enabling the module to assess behavioral patterns over time rather than in isolation. Pattern-matching logic may be applied to the sequence of classified actions to determine the significance and persistence of observed behaviors. The scoring process may incorporate both the type of behavior and its temporal characteristics, such as duration, frequency, and continuity. For example, a behavior classified as loitering may initially contribute a low score, but the score increases progressively as the duration of loitering exceeds predefined thresholds. Similarly, repeated occurrences of certain behaviors within a given time window, or combinations of behaviors (e.g., circling followed by loitering), may result in amplified scores. In some implementations, behavior classes may be assigned baseline severity weights, which are adjusted using temporal factors and confidence scores from the action recognition model. Scorer 712 may also apply smoothing or decay functions to ensure that scores evolve consistently over time and to prevent abrupt fluctuations due to transient or misclassified actions. Scorer 712 may output a behavior score representing the assessed level of suspicious activity, along with an associated pattern label identifying the specific threat-relevant behavior or behavior sequence detected. These outputs may be continuously updated as new frame data is processed and are provided to downstream components for integration into an overall threat assessment.

With continued reference to FIG. 7, active threat detection process 700 may include performing license plate recognition 714. In some embodiments, active threat detection process 700 may include detecting a license plate number using license plate recognition 714. License plate recognition 714 may include detecting a license plate number, wherein detecting a license plate number comprises detecting license plate regions within a frame of the plurality of frames using a localization model. In some embodiments, detecting a license plate number may include performing optical character recognition on a license plate region to extract a license plate number. In some embodiments, for each detection event, the identified vehicle and extracted plate string, associated confidence score, camera ID, and/or timestamp may be recorded. This data may, in some embodiments, be forwarded directly to active threat score rollup 716 without an intermediate analysis stage. The active threat score rollup 716 may optionally compare the extracted vehicle and plate string against a user-defined vehicle watchlist specified in the user configuration file.

With continued reference to FIG. 7, active threat detection process 700 may include performing scene anomaly detection 718. In some embodiments, scene anomaly detection 718 may evaluate deviations between the current camera frame and a stored baseline representation of the scene under nominal conditions. This stream, in some embodiments, may not rely on trained neural network models; instead, it may employ classical computer vision techniques based on pixel-level signal processing. In some embodiments, scene anomaly detection 718 may include receiving a frame of the plurality of frames, wherein the frame is associated with a scene and retrieving a baseline representation of the scene. 718 may be configured to determine an anomaly deviation by performing pixel-level signal processing to compare the frame to the baseline representation. In certain implementations, background modeling algorithms such as MOG2 (Mixture of Gaussians, version 2) may be utilized. These methods may represent each pixel as a probabilistic mixture of Gaussian distributions that are continuously updated over time. Pixels that deviate significantly from the modeled background may be classified as foreground and aggregated to generate a scene change score. Such approaches inherently accommodate gradual environmental variations, including lighting changes and natural motion (e.g., vegetation), thereby reducing false positives. For higher-fidelity comparison, a Structural Similarity Index Measure (SSIM) may be used to quantify differences in luminance, contrast, and structural composition between the current frame and the baseline. SSIM is more sensitive to semantically meaningful alterations, such as vandalism or physical damage, while remaining robust to noise and minor visual fluctuations. In the threat context, relevant scene changes may include but are not limited to: the forced opening of doors or windows, the appearance of previously absent objects (e.g., packages, tools, or potential weapons), unauthorized entry points being created or accessed, displacement or removal of secured items, or other alterations indicative of intrusion, tampering, or preparatory actions associated with malicious activity.

With continued reference to FIG. 7, active threat detection process 700 may include a location analysis 720. Location analysis 720 may include receiving track data from a tracking algorithm, wherein the track data includes historical positional data for a tracked entity. Location analysis 720 may interpret historical positional data for each tracked entity within the context of the camera's defined spatial zones. Location analysis 720 may predict a future trajectory for the tracked entity as a function of its track data. Location analysis 720 may determine a proximity score for the tracked entity as a function of comparing the future trajectory to a plurality of risk proximity zones. For each tracked entity, location analysis 720 may determine the current zone occupancy, and compute dwell time (defined as the continuous duration of presence within a given zone). In some embodiments, proximity score may be calculated based on both distance to and projected movement toward designated sensitive areas. Dwell time thresholds may be configurable on a per-zone basis. In the threat context, the relevant zones may be threat risk proximity zones, configurable regions around entry points (e.g., doors, windows), restricted access areas, high-value assets, secured perimeters, and other defined sensitive areas. Entities with predicted trajectories directed toward sensitive zones may be assigned higher proximity scores relative to those moving away, enabling risk differentiation based on both spatial position and directional intent.

With continued reference to FIG. 7, active threat detection process 700 may include an audio event classifier 722. If the camera is equipped with a microphone, this step is executed; otherwise this step is skipped. Where audio input is available, audio event classifier 722 may be configured to identify sound events using a sound event detection model as a function of an audio buffer associated with the plurality of frames. The audio buffer may be segmented into discrete time windows, each of which is analyzed to identify acoustic patterns corresponding to predefined event classes. These classes may be selected for relevance to threat assessment and may include, but are not limited to, glass breaking, shouting, aggressive or distressed vocalizations, impact sounds, and weapon-related audio signatures such as gunshots. Audio event classifier 722 may be trained to distinguish between ambient background noise and salient acoustic events, enabling robust classification under varying environmental conditions, including indoor and outdoor settings. In some implementations, audio event classifier 722 may incorporate spectral features, temporal patterns, or learned embeddings derived from audio waveforms to improve classification accuracy. Each processed audio segment may produce one or more event classifications with associated confidence scores. These outputs may be temporally aligned with the corresponding video frames and associated tracked entities where applicable.

With continued reference to FIG. 7, active threat detection process 700 may include a threat audio scorer 724 configured to assign a threat audio score to the event classes. Threat audio scorer 724 may be configured to evaluate outputs from audio event classifier 722, in conjunction with concurrent visual detection data from other analytical streams, including object detection, concealment detection, and action recognition. Threat audio scorer 724 may receive detected audio event types, associated confidence scores, and temporal information, and correlates these with visual events occurring within the same or overlapping time windows. The scoring process may incorporate both the type of audio event and its confidence level, with different event classes assigned baseline severity weights based on their relevance to potential threats. These weights may be further adjusted based on temporal alignment with visual signals. As a non-limiting example, an audio event such as shouting or a loud impact may contribute to a moderate score when occurring in isolation, but results in a significantly elevated score when coinciding with visual indicators such as aggressive behavior, rapid movement, or the presence of a weapon. In some implementations, threat audio scorer 724 may apply temporal correlation logic to determine whether audio and visual events occur within a predefined synchronization window, ensuring that only meaningfully related events are combined. Repeated or sustained audio events over time may further increase the score, while transient or low-confidence detections may be attenuated through smoothing or decay functions. Threat audio scorer 724 may output an audio threat score representing the assessed risk associated with detected audio events in context, which is continuously updated as new audio and visual data are processed. This score is provided to downstream aggregation components, where it may contribute to a comprehensive, multi-modal threat assessment.

With continued reference to FIG. 7, active threat detection process 700 may include active threat score rollup 716. Active threat score rollup 716 may consolidate the outputs of all active detection streams into a single composite threat score. As a limiting example, active threat score rollup 716 may be configured to combine the object score, the suspicious behavior score, the license plate number, the scene anomaly, and the proximity score, and/or threat audio score into the active threat score. In some embodiments, each stream's score may be multiplied by a configurable weight reflecting its relative importance for the specific user or deployment instance. The rollup may consume user-configured threat preferences at pipeline initialization, including per-stream sensitivity thresholds, per-class alert weights, suppression rules for specific contexts, and an overall alert sensitivity level, allowing the pipeline to be tuned to the specific risk profile of each deployment. The resulting composite score, along with all individual stream scores and their contributing factors, may be written to an activity log. Active threat score rollup 716 may load in user configuration 726, wherein user configuration 726 may include, as non-limiting examples, per-stream sensitivity thresholds, per-class alert weights, suppression rules for specific contexts, and an overall alert sensitivity level.

With continued reference to FIG. 7, if the person is still in frame, the pipeline may loop back to ATD Process Manager 704, initiating a new round of stream dispatch and analysis for the subsequent Stamped Frame. Active threat score from active threat score rollup 716 may be logged using Log and Notification process 1000.

### Safety Detection Process

With continued reference to FIG. 1, layered surveillance system 100 may be configured to perform a safety detection process 800. In some embodiments, safety detection process 800 may receive enriched stamped frames including, as non-limiting examples, tracking ID (per-camera), bounding box, appearance embedding, and/or track age (frames since first detection).

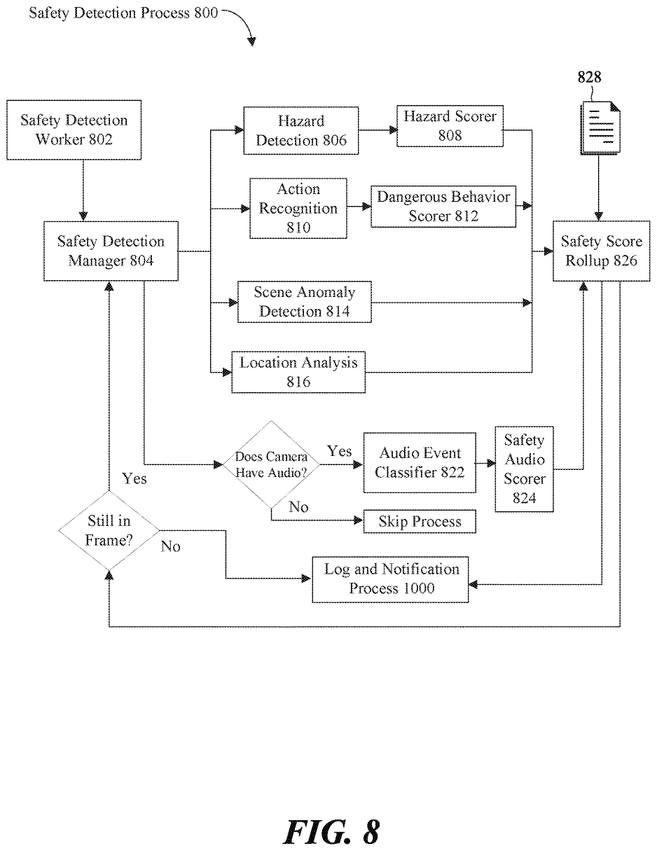

Referring now to FIG. 8, safety detection process 800 may be the platform's real-time behavioral and contextual safety analysis pipeline; an automated, multi-stream evaluation workflow that assesses enriched Stamped Frame data for indicators of potential safety hazards across multiple independent analytical dimensions. Safety detection process 800 may include receiving its inputs from shared analysis pools. Safety detection process 800 may route each Stamped Frame through a set of parallel detection streams, each focused on a distinct safety vector, before consolidating their outputs into a unified safety hazard score that drives suppress-or-escalate decisions and any resulting alerts or downstream actions.

Safety detection process 800 may be organized around parallel stream execution followed by a single consolidation stage. Each detection stream may operates independently, analyzing the StampedFrame data through its designated lens and producing a weighted sub-score reflecting its assessed hazard contribution. Upon completion of all streams, a weighted rollup stage may aggregate the individual stream outputs into a single composite safety hazard score, which is then evaluated by a separate downstream process responsible for determining the appropriate system response.

In some embodiments, all work items may enter the pipeline via a managed queue. StampedFrames awaiting safety evaluation may be held in the inbound analysis queue; upon completion, the composite safety hazard score and associated evaluation data are written to a log. A separate downstream process monitors that log and is responsible for determining the appropriate system response. This queue-based input architecture decouples each detection stream from the others and from the consolidation stage, allowing each component to operate at independent concurrency levels and enabling the pipeline to recover gracefully from transient failures without loss of work. The log-based output architecture similarly decouples the SD process from downstream processes, allowing multiple concurrent processes (such as active threat detection, facial recognition, and other analytical subsystems) to independently read from and act upon the safety log without direct coupling to the SD pipeline itself.

Safety detection process 800 is not exclusively scoped to scenarios in which a person is present within the frame. Depending on the user's configuration and selected service tier, safety detection process 800 may operate in a continuous environmental monitoring mode, evaluating incoming StampedFrame data for ambient hazards (such as fallen trees, fire, smoke, flooding, or wildlife intrusion) regardless of whether any individual is detected in the scene.

With continued reference to FIG. 8, safety detection process 800 may include a safety detection worker 802. Safety detection worker 802 may serve as the entry point of safety detection process 800. Safety detection worker 802 may ingest incoming Stamped Frame data from the inbound analysis queue and forwards it to safety detection manager 804 for analysis.

With continued reference to FIG. 8, safety detection process 800 may include safety detection manager 804. The safety detection manager 804 may be responsible for orchestrating the execution of all active detection streams within the Safety Detection pipeline. Upon receiving a StampedFrame, safety detection manager 804 may dispatch it to all active detection streams simultaneously and owns the safety event lifecycle, tracking which tracking IDs have active safety risk assessments in progress. To support detection of time-extended behaviors that cannot be identified from any single frame, safety detection manager 804 may maintain a shared temporal context store: a rolling time-window history of all track events, keyed by tracking ID. This store may be accessible to all detection stream analyzers and enables the identification of sustained or progressive behavioral patterns (such as a child moving toward a body of water, a person stumbling/gradually losing balance over time, etc.) that only become apparent when evaluated across multiple frames over time.

With continued reference to FIG. 8, safety detection process 800 may include hazard detection 806. In some embodiments, a hazard detection algorithm may be configured to generate a hazard score using a hazard-detection neural network. Hazard detection 806 may include a YOLO-based object detection model; this may be configured and trained to recognize safety-specific object classes, including but not limited to dangerous animals, water hazards, fire hazards, road hazards, elevated surfaces, unsecured machinery, and other environmental dangers. Hazard detection 806 algorithm may be trained using hazard detection training data correlating exemplary bounding boxes and frames to safety-specific object classes. Rather than operating on the entirety of an input image frame, hazard detection 806 is selectively applied to a dynamically generated subregion corresponding to a bounding box of a previously detected person and the surrounding area. This bounding box is produced by an upstream person detection and tracking process and represents the spatial extent of the individual within the scene, and is subsequently enlarged to incorporate relevant surrounding context. By restricting inference to this cropped region of interest, the system may significantly reduce computational overhead, enabling faster processing and improved scalability across multiple concurrent video streams. Additionally, this targeted approach reduces the likelihood of false positive detections by eliminating irrelevant background regions and focusing the model's attention on areas most likely to contain safety-related objects, particularly those in proximity to a person. The outputs of hazard detection hazard detection 806 model may be associated with each tracked entity, along with corresponding confidence scores. This association enables downstream components of the system to incorporate safety risk object presence into a unified threat assessment framework.

With continued reference to FIG. 8, safety detection process 800 may include a hazard scorer 808. Hazard scorer 808 may be configured to evaluate outputs from the hazard detection stream in conjunction with track history data from a temporal context store. The temporal context store may maintain historical detection data for each tracked entity, including previously detected object classes, and confidence scores, enabling the module to assess safety relevance over time rather than on a single-frame basis. Hazard scorer 808 incorporates both the type of detected hazard and its associated confidence level, as well as temporal characteristics such as persistence and recurrence across frames. Hazard classes are assigned baseline severity weights, which are scaled using detection confidence and adjusted based on temporal consistency. For example, a single low-confidence detection of a potential hazard may contribute minimally to the score, whereas repeated high-confidence detections across consecutive frames result in a significantly elevated hazard score. Hazard scorer 808 may output a hazard score representing the assessed risk associated with detected objects. These outputs may be continuously updated as new detection data is received and are provided to downstream components for integration into a comprehensive threat assessment framework.

With continued reference to FIG. 8, safety detection process 800 may include action recognition 810. Action recognition 810 may include a safety action recognition algorithm. Safety action recognition algorithm may be trained on a set of behavior classes pertaining to safety risk assessment and configured to receive a sequence of the plurality of frames as input and output a dangerous behavior score. Action recognition 810 may receive, as input, a sequence of frames associated with a persistent tracking ID generated by an upstream tracking system, thereby enabling consistent observation of a single entity across time. This temporal input may allow the model to capture motion patterns, trajectory information, and contextual changes that are not discernible from individual frames in isolation. Action recognition 810 may be trained on a set of behavior classes specifically selected for safety assessment applications. These classes include, but are not limited to, falling, climbing elevated structures, running near water, stumbling, an elderly person losing balance, a child crawling near a road or pool edge, and other behavior's that indicate acute physical danger. In some implementations, additional contextual features (such as proximity to hazardous areas, dangerous interaction with other tracked entities, or deviations from typical movement patterns) may be incorporated into the classification process to improve accuracy and relevance. Action recognition 810 may utilize architectures designed for spatiotemporal analysis, including but not limited to 3D convolutional neural networks (3D CNNs), recurrent neural networks (RNNs), long short-term memory (LSTM) networks, temporal convolutional networks (TCNs), or transformer-based sequence models. In certain implementations, the model may also incorporate optical flow, pose estimation data, or trajectory embeddings to enhance sensitivity to motion dynamics and behavioral cues. The output of action recognition 810 may include one or more behavior classifications associated with each tracked entity, along with corresponding confidence scores. These outputs may be aligned with the tracking system and may be updated continuously as new frames are processed, enabling real-time or near-real-time behavioral assessment.

With continued reference to FIG. 8, safety detection process 800 may include a dangerous behavior scorer 812. Pattern-matching logic may be applied to the sequence of classified actions to determine the significance and persistence of observed behaviors. The scoring process incorporates both the type of behavior and its temporal characteristics, such as duration, frequency, and continuity. For example, a behavior classified as proximity to a hazard may initially contribute to a low score, but the score increases progressively as the duration of proximity to a hazard exceeds predefined thresholds. Similarly, repeated occurrences of certain behaviors within a given time window, or combinations of behaviors (e.g., proximity to a hazard followed by loss of balance/stumbling), may result in amplified scores. In some implementations, behavior classes are assigned baseline severity weights, which are adjusted using temporal factors and confidence scores from the action recognition model. The module may also apply smoothing or decay functions to ensure that scores evolve consistently over time and to prevent abrupt fluctuations due to transient or misclassified actions. Scorer 812 may output a behavior score representing the assessed level of dangerous activity, along with an associated pattern label identifying the specific safety-relevant behavior or behavior sequence detected. These outputs may be continuously updated as new frame data is processed and are provided to downstream components for integration into an overall threat assessment.

With continued reference to FIG. 8, safety detection process 800 may include scene anomaly detection 814. In some embodiments, scene anomaly detection 814 may evaluate deviations between the current camera frame and a stored baseline representation of the scene under nominal conditions. This stream, in some embodiments, may not rely on trained neural network models; instead, it may employ classical computer vision techniques based on pixel-level signal processing. In some embodiments, scene anomaly detection 814 may include receiving a frame of the plurality of frames, wherein the frame is associated with a scene and retrieving a baseline representation of the scene. Scene anomaly detection 814 may be configured to determine an anomaly deviation by performing pixel-level signal processing to compare the frame to the baseline representation. In certain implementations, background modeling algorithms such as MOG2 (Mixture of Gaussians, version 2) may be utilized. These methods may represent each pixel as a probabilistic mixture of Gaussian distributions that are continuously updated over time. Pixels that deviate significantly from the modeled background may be classified as foreground and aggregated to generate a scene change score. Such approaches inherently accommodate gradual environmental variations, including lighting changes and natural motion (e.g., vegetation), thereby reducing false positives. For higher-fidelity comparison, a Structural Similarity Index Measure (SSIM) may be used to quantify differences in luminance, contrast, and structural composition between the current frame and the baseline. SSIM is more sensitive to semantically meaningful alterations, such as vandalism or physical damage, while remaining robust to noise and minor visual fluctuations. In the safety context, relevant scene changes may include but are not limited to: the removal of a pool cover, an unsecured or open gate, structural damage to a fence, or other alterations to the physical environment that introduce hazardous conditions independent of the presence or detection of any individual. This processing stream further functions as a rapid preliminary indicator of abrupt events, such as a person entering or falling into a pool, wherein a substantial instantaneous deviation in scene representation can trigger increased weighting or priority in parallel analytical streams prior to those streams accumulating sufficient temporal data to reach a high-confidence assessment.

With continued reference to FIG. 8, safety detection process 800 may include location analysis 816. Location analysis 816 may include receiving track data from a tracking algorithm, wherein the track data includes historical positional data for a tracked entity. Location analysis 816 may interpret historical positional data for each tracked entity within the context of the camera's defined spatial zones. Location analysis 816 may predict a future trajectory for the tracked entity as a function of its track data. Location analysis 816 may determine a proximity score for the tracked entity as a function of comparing the future trajectory to a plurality of hazard proximity zones. For each tracked entity, location analysis 816 may determine the current zone occupancy. compute dwell time (defined as the continuous duration of presence within a given zone). In some embodiments, proximity score may be calculated based on both distance to and projected movement toward designated sensitive areas. Dwell time thresholds may be configurable on a per-zone basis. In the safety context, the relevant zones are hazard proximity zones, configurable regions around pool edges, road boundaries, stairwells, drop hazards, and other defined danger areas. Entities with predicted trajectories directed toward sensitive zones may be assigned higher proximity scores relative to those moving away, enabling risk differentiation based on both spatial position and directional intent.

With continued reference to FIG. 8, safety detection process 800 may include an audio event classifier 822. If the camera is equipped with a microphone, this step is executed; otherwise this step is skipped. Where audio input is available, audio event classifier 822 may be configured to identify sound events using a sound event detection model as a function of an audio buffer associated with the plurality of frames. The audio buffer may be segmented into discrete time windows, each of which is analyzed to identify acoustic patterns corresponding to predefined event classes. These classes are selected for relevance to safety assessment and may include, but are not limited to, screaming, crying, splashing, and impact sounds consistent with a fall. Audio event classifier 822 may be trained to distinguish between ambient background noise and salient acoustic events, enabling robust classification under varying environmental conditions, including indoor and outdoor settings. In some implementations, audio event classifier 822 may incorporate spectral features, temporal patterns, or learned embeddings derived from audio waveforms to improve classification accuracy. Each processed audio segment may produce one or more event classifications with associated confidence scores. These outputs may be temporally aligned with the corresponding video frames and associated tracked entities where applicable.

With continued reference to FIG. 8, safety detection process 800 may include a safety audio scorer 824 configured to assign a safety audio score to the event classes. Safety audio scorer 824 may be configured to evaluate outputs from audio event classifier 822, in conjunction with concurrent visual detection data from other analytical streams, including object detection, concealment detection, and action recognition. Safety audio scorer 824 may receive detected audio event types, associated confidence scores, and temporal information, and correlates these with visual events occurring within the same or overlapping time windows. he scoring process incorporates both the type of audio event and its confidence level, with different event classes assigned baseline severity weights based on their relevance to potential safety risks. These weights are further adjusted based on temporal alignment with visual signals. For example, an audio event such as a repeated splashing sound may contribute to a moderate score when occurring in isolation, but results in a significantly elevated score when coinciding with visual indicators such as a person near a pool edge or erratic movement within the water. In some implementations, safety audio scorer 824 may apply temporal correlation logic to determine whether audio and visual events occur within a predefined synchronization window, ensuring that only meaningfully related events are combined. Repeated or sustained audio events over time may further increase the score, while transient or low-confidence detections may be attenuated through smoothing or decay functions. Safety audio scorer 824 may output an audio safety score representing the assessed risk associated with detected audio events in context, which is continuously updated as new audio and visual data are processed. This score is provided to downstream aggregation components, where it may contribute to a comprehensive, multi-modal safety assessment.

With continued reference to FIG. 8, safety detection process 800 may include safety score rollup 826. Safety score rollup 826 consolidates the outputs of all safety detection streams (such as, Hazard detection, Action recognition, Scene anomaly detection, Location and Trajectory Analysis, and Audio event classifier) into a single composite safety risk score. Safety score rollup 826 may be configured to, in some embodiments, combine the hazard score, dangerous behavior score, scene anomaly detection score, location analysis score, and/or safety audio score into the safety score. Each stream's score may be multiplied by a configurable weight reflecting its relative importance for the specific user or deployment instance. The rollup consumes user-configured safety preferences at pipeline initialization from, for example user configuration 828, including per-stream sensitivity thresholds, per-class alert weights, suppression rules for specific contexts, and an overall alert sensitivity level, allowing the pipeline to be tuned to the specific risk profile of each deployment as non-limiting examples. The resulting safety score, along with all individual stream scores and their contributing factors, may be written to the activity log, for example using Log and Notification process 1000.

### Facial Recognition Process

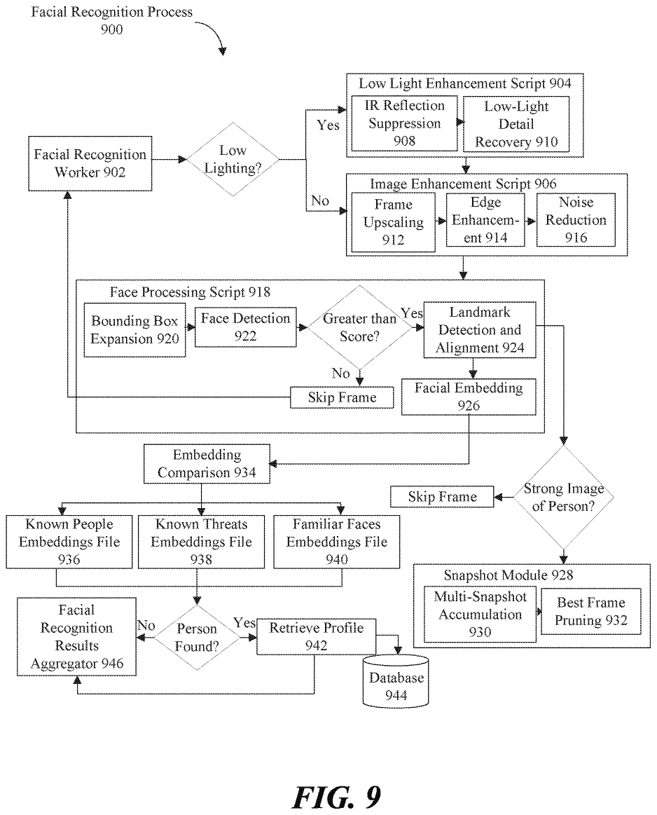

Referring to FIG. 9, a flow diagram of an exemplary facial recognition process 900 is shown. The Facial Recognition (FR) process 900 may be part of layered surveillance system 100 real-time identification pipeline; an automated evaluation workflow that assesses enriched StampedFrame data to identify individuals present within the frame. Receiving its inputs from shared analysis pools, exemplary facial recognition process 900 may isolate and process each detected person region, progressively refining the facial image before comparing it against known embedding sets to produce an identification result.

With continued reference to FIG. 9, exemplary facial recognition process 900 may be organized around a sequential per-face processing workflow. For each Stamped Frame, exemplary facial recognition process 900 may extract the person region identified by the YOLO person detection model, apply image enhancement, and expand the bounding box before passing the region to InsightFace, an open-source facial analysis framework that provides face detection, alignment, and embedding generation capabilities through a set of underlying AI models (such as the buffalo_1 deep convolutional neural network) that can be swapped out to suit specific accuracy, performance, or deployment requirements. InsightFace may be used to perform face detection and alignment on the extracted region, then to generate a facial embedding from the aligned face. This embedding may be compared against three existing embedding sets: Known People, Known Threats, and Familiar Faces. Each embedding set may be scoped to the individual user or deployment instance, ensuring that identification and recognition operate entirely within the boundaries of that user's configured data. If a match is found, the pipeline may query the database to retrieve the associated person record and returns the identified result. If no match is found, the individual is returned as unknown.

With continued reference to FIG. 9, a dedicated subprocess, the snapshot module, may operate concurrently alongside the main identification workflow. For each processed face, the Snapshot Module may compare the current face image against any previously saved snapshot for that individual and, if the new image is of higher quality, replaces the stored snapshot. In cases where an individual remains unidentified, the snapshot module's saved images may be used to generate a new facial embedding, which may be then written to the Familiar Faces embedding file, allowing the individual to be recognized in subsequent frames or sessions.

With continued reference to FIG. 9, in some embodiments, all work items may enter exemplary facial recognition process 900 using a managed queue. Stamped Frames awaiting facial recognition may be held in the inbound analysis queue; upon completion, identification results and any associated records may be written to a log. A separate downstream process may monitor that log and is responsible for determining the appropriate system response. This queue-based input architecture decouples each processing stage from the others, allowing each component to operate at independent concurrency levels and enabling the pipeline to recover gracefully from transient failures without loss of work. The log-based output architecture similarly decouples the FR process from downstream consumers, allowing multiple concurrent processes (such as active threat detection, safety detection, and other analytical subsystems) to independently read from and act upon the identification log without direct coupling to the FR pipeline itself.

With continued reference to FIG. 9, exemplary facial recognition process 900 may include a facial recognition worker 902. Facial recognition worker 902 may serve as the entry point of exemplary facial recognition process 900. Facial recognition worker 902 may ingest incoming Stamped Frame data from an inbound analysis queue and may be responsible for orchestrating the execution of the pipeline.

With continued reference to FIG. 9, exemplary facial recognition process 900 may include one or more image improvement scripts. Image improvement scripts may include a low light enhancement script 904 and/or an image enhancement script 906. In some embodiments, low light enhancement script 904 may be run if an input frame is in low light. In some embodiments, image enhancement script 906 may be run if an input frame is not in low light.

With continued reference to FIG. 9, low light enhancement script 904 may be conditionally executed based on ambient lighting conditions detected in the captured frame. In low-light conditions, raw captured frames often contain artifacts and deficiencies that can negatively impact the accuracy of facial detection and recognition. To address this, the system may apply targeted pre-processing operations to improve image quality before any facial analysis is attempted. Low light enhancement script 904 may include a step of infrared (IR) reflection suppression 908. A known artifact of IR-assisted capture is the generation of anomalous high-intensity reflections from specular surfaces within the scene; most notably, the corneal and scleral surfaces of a subject's eyes. These IR-induced reflections manifest as localized regions of overexposure or “glowing,” which can obscure or distort the periocular region of the subject's face. Such distortion directly degrades the reliability and accuracy of downstream facial detection and recognition operations by corrupting the feature data associated with one of the most diagnostically significant regions of the human face. To mitigate this effect, reflection suppression 908 may be applied including a composite filtering operation consisting of, in some embodiments, a Gaussian blur kernel in conjunction with a threshold-based masking technique. The Gaussian blur may function to attenuate high-frequency intensity spikes caused by IR reflections, while the threshold mask may be applied to isolate and suppress pixel regions exceeding a defined luminance boundary, effectively neutralizing the overexposed artifacts without materially degrading the surrounding facial feature data. Low light enhancement script 904 may also include a step of low-light detail recovery 910. Under low-light imaging conditions, the captured frame may exhibit reduced local contrast, suppressed textural detail, and diminished feature definition; all of which can adversely affect the performance of facial detection and biometric recognition algorithms that rely on the accurate representation of fine structural features. To recover lost detail and improve the perceptual and computational quality of the image, the system may apply a two-stage enhancement (low-light detail recovery 910). In the first stage, Contrast Limited Adaptive Histogram Equalization (CLAHE) may be applied to the image. Unlike standard global histogram equalization, which computes a single histogram across the entire image and can disproportionately amplify contrast in dominant intensity regions while suppressing detail elsewhere, CLAHE divides the image into a grid of localized sub-regions, referred to as tiles, and performs histogram equalization independently within each tile. A contrast-limiting threshold may be enforced during this process; any histogram bins that exceed the defined clip limit are redistributed across the remaining intensity levels, preventing the noise amplification that would otherwise occur in regions of near-uniform intensity. The resulting output may exhibit a balanced enhancement of local contrast across the full image, recovering fine textural and structural detail that would otherwise be indistinguishable in the low-light source frame, while preserving the relative tonal relationships between regions. This is particularly important for facial analysis, as subtle variations in shading and texture across facial features (such as the contours of the eyes, nose, and mouth) are critical inputs to detection and recognition algorithms. In the second stage, a bilateral filter may be applied to the CLAHE-processed image. The bilateral filter may perform edge-preserving smoothing by computing a weighted average of neighboring pixels, where the weights are determined jointly by two independent factors: spatial proximity, which reduces the influence of pixels further from the target pixel, and radiometric similarity, which reduces the influence of pixels whose intensity values differ significantly from the target. This dual-weighting mechanism may allow the filter to smooth low-contrast, noisy regions of the image (such as skin surfaces and background areas), while leaving high-contrast boundaries, such as the edges defining facial features, largely intact. This operation reduces residual noise introduced during low-light capture without blurring the structural boundaries that are critical to accurate facial feature extraction.

With continued reference to FIG. 9, prior to facial detection and recognition processing, the system may apply a series of image pre-processing techniques to improve the overall quality of the captured frame. These enhancements may be applied universally, regardless of lighting conditions, and are designed to increase the reliability and accuracy of facial analysis; particularly under sub-optimal capture conditions such as motion blur caused by rapid subject movement, low effective resolution resulting from the subject being positioned at a significant distance from the camera, or partial obstruction of the subject's face. In some embodiments, image enhancement script 906 may include fame upscaling 912. When the subject is far from the camera, or when the capture device produces a lower-resolution output, the facial region within the frame may occupy too few pixels to be accurately analyzed by the downstream facial recognition model. Insufficient image resolution reduces the amount of spatial detail available to the model and can result in failed or inaccurate detections. To address this, upscaling 912 may apply a 2x upscaling operation to the frame using bicubic interpolation, implemented via cv2.resize( ). Bicubic interpolation may enlarge the image by computing the value of each new pixel based on the weighted average of the 16 nearest pixels in the original image, producing a smoother and more detail-preserving result compared to simpler methods such as nearest-neighbor or bilinear interpolation. The resulting upscaled frame may provide a larger working canvas with improved spatial definition, increasing the likelihood of successful facial region detection and feature extraction by the facial recognition model. Image enhancement script 906 may include edge enhancement 914. Even in adequately lit and sufficiently resolved frames, the facial features of the subject may lack the sharpness required for reliable detection and recognition. This can occur as a result of motion blur, camera focus inconsistencies, or natural softness introduced during image capture and compression. When facial boundaries and features are not clearly defined, recognition models may struggle to accurately locate and differentiate key facial landmarks. To improve feature definition, edge enhancement 914 may apply an edge enhancement operation using an unsharp mask in combination with a Laplacian kernel. The unsharp mask may work by subtracting a blurred version of the image from the original, amplifying the high-frequency components that correspond to edges and fine detail. The Laplacian kernel complements this by detecting regions of rapid intensity change (such as the boundaries of the eyes, nose, and mouth) and reinforcing their contrast relative to surrounding areas. Together, these operations may produce a sharpened image in which facial features are more clearly defined and distinguishable, improving the ability of the facial recognition model to accurately identify and process facial landmarks. In some embodiments, image enhancement script 906 may include noise reduction 916. Upscaling 912 and edge enhancement 914, while effective at improving image resolution and feature definition, can introduce additional noise into the frame as a side effect. Upscaling can amplify existing low-level image noise by spreading it across a larger pixel area, and edge enhancement operations can inadvertently increase the visibility of high-frequency noise artifacts alongside genuine edge detail. If left unaddressed, this noise can interfere with the facial recognition model's ability to accurately interpret the image. To mitigate this, noise reduction 916 may apply Gaussian smoothing to the enhanced frame. Gaussian smoothing operates by convolving the image with a Gaussian kernel, which computes a weighted average of each pixel and its neighbors, with greater weight assigned to pixels that are closer to the center of the kernel. This selectively attenuates high-frequency noise while preserving the lower-frequency structural information and the edge detail recovered in the preceding steps, producing a cleaner image that retains the enhancements applied during upscaling and sharpening without the compounding effect of residual noise.

With continued reference to FIG. 9, exemplary facial recognition process 900 may include a face processing script 918. Face processing script 918 may operate on the pre-processed image data output by low light enhancement script 904 and/or image enhancement script 906, and may be responsible for detecting faces within each frame, evaluating image quality, and/or generating a numerical representation (embedding) of the detected face when sufficient quality criteria are met.

With continued reference to FIG. 9, face processing script 918 may include bounding box expansion 920. Upon initial person detection, a bounding box may be generated around the identified individual. This bounding box may be programmatically expanded, using box expansion 920 beyond its original dimensions by a predetermined percentage of the bounding box's own width and height, ensuring that no relevant facial features are truncated due to tight cropping or movement within the frame. The expanded region of interest may then be extracted and passed forward as the input for subsequent face detection operations. This step improves detection robustness by ensuing contextual facial information such as hairline, chin, partial pose variations, and the like are preserved.

With continued reference to FIG. 9, face processing script 918 may include face detection 922. The system may perform face detection on the expanded region of interest using the InsightFace framework, which may employ a deep learning based detection model to localize and classify facial regions within the image. This detection process may analyze the input region at multiple scales to identify candidate areas that exhibit structural and textural characteristics consistent with human faces. For each candidate region, the model produces a bounding box along with an associated confidence score, which represents the probability that the region contains a valid and sufficiently complete human face. The confidence score may be derived from the InsightFace model's internal classification layers, which evaluate features such as facial symmetry, consistency of expected landmark positions, and overall geometric structure. In doing so, the system may not only determine the presence of a face but also implicitly assesses the quality and usability of the detection. Factors such as occlusion, extreme pose variation, motion blur, low resolution, and poor lighting conditions may negatively impact the confidence score, as they reduce the model's ability to reliably identify a full and properly formed face. This confidence score may serve as a gating mechanism for subsequent stages in face processing script 918. Only detections that exceed a predefined threshold are considered valid and forwarded for further processing. In some embodiments, based on a confidence score exceeding a confidence score threshold, face processing script 918 may proceed to landmark detection and alignment 924. In some embodiments, based on a confidence score exceeding 0.5, face processing script 918 may proceed to landmark detection and alignment 924.

With continued reference to FIG. 9, landmark detection and alignment 924 may include utilizing the InsightFace framework to identify a predefined set of facial landmarks corresponding to key anatomical reference points, including but not limited to the centers of the eyes, the tip of the nose, and the corners of the mouth. These landmarks may be extracted through a neural network based regression model that predicts pixel coordinates for each feature point within the detected face region. The spatial arrangement of these landmarks provides a structured representation of the face's geometry. The detected landmarks may then be used to perform geometric normalization of the face through an affine transformation or similar alignment technique. Specifically, the detected landmark coordinates may, in some embodiments, be mapped to a canonical reference configuration, effectively rotating, scaling, and translating the face into a standardized orientation. This process may compensate for variations in head pose, camera angle, and distance from the camera, ensuring that the eyes, nose, and mouth are consistently positioned across all processed images. In addition to correcting pose and rotation, the alignment process may also, in some embodiments, reduce intra-class variability caused by environmental factors such as camera perspective and subject movement. By normalizing facial geometry prior to feature extraction, the system may ensure that downstream embedding generation operates on a consistent input format, thereby improving the robustness, repeatability, and accuracy of identity matching across different frames, sessions, and capture conditions.

With continued reference to FIG. 9, landmark detection and alignment 924 may include generating a facial embedding 926 for each bounding box. The system may utilize embedding-based representation to enable scalable, real-time identity matching by leveraging computationally efficient numerical vector comparisons that remain robust to variations in lighting, expression, and minor pose differences. Facial embedding 926 may be generated using the InsightFace framework. The aligned facial image may be passed through the model, which extracts high-level discriminative features and encodes them into a fixed-length, 512-dimensional feature vector. This vector represents the unique facial characteristics of the individual in a compact numerical form, capturing both global structure and fine-grained facial details. Where beneficial, alternative compatible face recognition models may be substituted in place of the buffalo_1 model without departing from the overall system architecture.

With continued reference to FIG. 9, if there are not enough stored images of a person to reliably generate facial embedding 926 then, snapshot module 928 may be called. Snapshot module 928 may be responsible for evaluating newly captured frames of the subject's face against the existing set of stored reference images. When a newly captured frame is determined to be of superior quality or utility relative to an existing stored image, the new frame may be retained and the inferior image is removed from the set. This ensures that the stored image set is continuously refined over time, maintaining a collection of the highest-quality and most representative frames available for each subject. In the event that the subject is subsequently matched against an existing embedding file and successfully identified, the stored snapshot images are discarded as they are no longer required. Conversely, if the subject remains unidentified (indicating that they have not been previously encountered by the system) the accumulated snapshot images are passed to a downstream process responsible for generating a new facial embedding for the subject, which is then stored for use in future recognition attempts. Snapshot module 928 may include multi-snapshot accumulation 930. A facial recognition embedding generated from images captured at a single angle or orientation provides an incomplete representation of the subject's facial geometry, reducing recognition accuracy when the subject is encountered at a different angle in subsequent frames. To produce a comprehensive and robust embedding, the system may require reference images that collectively capture the subject's face across a range of orientations and positions. To achieve this, the system may actively seek to accumulate frames that represent distinct angular perspectives of the subject's face (including frontal, left profile, right profile, and intermediate angles). As new frames are captured, the system may evaluate the pose orientation of the detected face and prioritizes the retention of frames that introduce angular coverage not already well represented in the existing stored set. By ensuring that the reference image set encompasses the various sides and features of the subject's face, the resulting embedding is more comprehensive and better equipped to support accurate recognition across a wider range of real-world capture conditions. Snapshot module 928 may include best frame pruning 932. To manage storage and ensure that the reference image set remains optimally composed, the system may maintain a fixed maximum number of stored images per subject. As new frames are captured and evaluated, the system may continuously assess whether incoming frames offer sufficient quality or coverage to warrant inclusion in the stored set, and if so, which existing frame should be displaced to accommodate the new addition. This evaluation may be performed by scoring both the incoming frame and the existing stored frames against a set of defined quality and utility criteria. These criteria include, but are not limited to: overall image sharpness and clarity, the degree to which the subject's face is free from obstruction or truncation, the proximity of the subject to the camera as reflected by the relative size of the detected facial region within the frame, and the angular orientation of the face as it relates to gaps in the existing angular coverage of the stored set. The incoming frame may only be retained if its composite score represents an improvement over the lowest-scoring frame currently in the stored set, in which case the inferior frame is removed and replaced. Through this process, the stored image set is pruned to contain only the most valuable frames necessary to construct a comprehensive and accurate facial embedding for the subject.

With continued reference to FIG. 9, exemplary facial recognition process 900 may include comparing each facial embedding against a facial embedding set. This may include an embedding comparison 934. The system may implement a multi-repository facial recognition architecture in which facial embeddings are organized into distinct repositories corresponding to different semantic classifications of individuals. In one embodiment, these repositories may include, as non-limiting examples, Known People, Known Threats, and Familiar Faces (unidentified individuals). These may include known people embeddings file 936, known threats embeddings file 938, and/or familiar faces embeddings file 940. Each repository may be logically scoped to a specific user, organization, or deployment instance, thereby ensuring that all recognition operations are performed exclusively within the boundaries of authorized and context-specific data. This isolation prevents cross-tenant data exposure and enables customization of recognition behavior on a per-deployment basis. The embedding generated at facial embedding 926 may be compared against stored embeddings within one or more repositories using a similarity metric, such as cosine similarity or Euclidean distance. In one embodiment, embeddings are normalized, allowing similarity to be efficiently computed as a dot product (a mathematical operation that multiplies corresponding values across two vectors and sums the results), producing a similarity score that reflects the degree of correspondence between the candidate embedding and stored entries. To support efficient matching at scale, the system may utilize indexed search methods, such as approximate nearest neighbor techniques, to identify a subset of likely candidate embeddings prior to final comparison. A match determination may be made by evaluating the similarity score against one or more configurable thresholds. In one embodiment, the system may define an acceptance threshold above which a candidate is considered a positive match, and a rejection threshold below which the candidate is classified as unknown. Intermediate ranges may be used to identify ambiguous matches requiring further validation. These thresholds may be statically defined, user-configurable, or dynamically adjusted based on environmental conditions, historical accuracy, or model calibration. In scenarios where multiple repositories yield valid matches, the system may apply a prioritization hierarchy to resolve classification conflicts. For example, matches within the Known Threats repository may take precedence over matches within the Known People repository, ensuring that risk-sensitive classifications override benign identifications. Additional tie-breaking logic may incorporate factors such as relative similarity score, frequency of prior matches, recency of observation, and associated metadata confidence If no repository produces a similarity score exceeding the defined acceptance threshold, the individual may be classified as unknown and may be processed for inclusion in the Familiar Faces repository.

With continued reference to FIG. 9, if there is a successful embedding match, then exemplary facial recognition process 900 may include retrieving profile 942. This may include retrieving a unique ID associated with the matched embedding entry. This may include assigning the unique ID to the bounding box associated with the matched embedding. This unique ID may serve as a persistent reference key that links the facial embedding to a corresponding record in the system database. Using this ID, the system may query database 944 to retrieve the full profile associated with the matched subject, which may include attributes such as the subject's name, registration details, and any other relevant information stored against their record. The retrieved profile may then be made available to downstream processes for use in subsequent handling, logging, or access control operations as appropriate.

With continued reference to FIG. 9, upon completion of all preceding processing steps, a facial recognition results aggregator 946 may consolidate the outputs produced throughout the pipeline into a single structured result. This may include the outcome of the embedding match, the confidence score associated with the match, the unique identifier of the matched subject where applicable, and/or the profile data. In cases where no match was found, the aggregated result reflects the unidentified status of the subject along with any relevant metadata collected during processing. The consolidated result may then be returned to the calling process, providing a complete and self-contained summary of the facial recognition outcome for the frame.

### Log and Notification Process

Referring back to FIG. 1, in some embodiments, layered surveillance system 100 may include a step of updating ID 116 associated with a bounding box/tracked entity with a verified ID based on the output of exemplary facial recognition process 900. This process may replace the provisional DeepSORT tracking ID with the verified person's ID, ensuring that all subsequent actions and analysis performed on that individual throughout their continued presence within the frame are accurately attributed and logged to the corresponding person record. This updated ID may be logged using Log and Notification process 1000.

With continued reference to FIG. 1, if a person's face is identified in the encoding files as described in exemplary facial recognition process 900, the images captured by the snapshot module in exemplary facial recognition process 900 are no longer required. Therefore these snapshots may be deleted 118.

With continued reference to FIG. 1, if a person's face is identified in the encoding files as described in exemplary facial recognition process 900, layered surveillance system 100 may evaluate a user configuration file 120 to determine whether any actions 122 need to be taken based on the identified individual. This may include, but is not limited to: alerting, access control enforcement, and IoT integration.

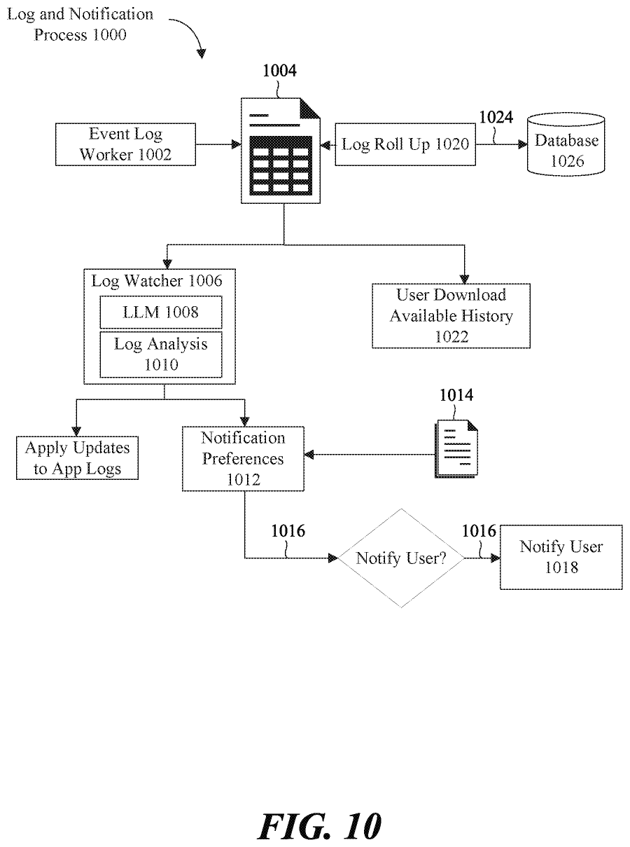

Referring now to FIG. 10, a flow diagram of an exemplary log and notification process 1000 is shown. Log and Notification process 1000 may be the platform's real-time event analytics, notification, and actions pipeline; an automated workflow that ingests event outputs from multiple upstream analytical processes (including Active Threat Detection, Safety Detection, Facial Recognition, and Passive Threat Detection) and synthesizes those inputs into a consolidated assessment of what is occurring within the monitored environment. The resulting insights may then be cross-referenced against the user configuration to determine and execute the appropriate system responses, including but not limited to notifications, access control triggers, and IoT integrations. Log and Notification process 1000 may include unified Activity Log that serves as the central aggregation point for all upstream process outputs. By consolidating the outputs of multiple independent streams into a single structured table, Log and Notification process 1000 may be able to analyze events holistically rather than in isolation, drawing cross-stream conclusions about the current state of activity within the frame. Where facial recognition has produced an identification, Log and Notification process 1000 may additionally query that individual's master record from the database, incorporating their historical activity data into the assessment so that real-time behavior can be evaluated in the context of known prior patterns. The resulting conclusions may be evaluated against the user configuration file, which defines the conditions and thresholds that govern system responses. This configuration-driven approach ensures that all notification, access control, and integration actions are fully user-defined and scoped to the individual deployment instance, with no cross-user or cross-instance data sharing. Actions may be executed in response to conclusions drawn from the Activity Log, with the full event record retained for audit, review, and downstream analytical purposes.

With continued reference to FIG. 10, Log and Notification process 1000 may include an event log worker 1002. Worker 1002 may serve as the entry point to Log and Notification process 1000. It is responsible for receiving incoming event data from upstream processes, validating and normalizing that data into a consistent structured format, and writing the resulting records to an activity log table 1004. Activity log table 1004 may serve as a central aggregation point for all upstream process outputs within Log and Notification process 1000. Rather than processing each upstream event stream in isolation, Log and Notification process 1000 may consolidate all incoming records into this unified table, enabling holistic cross-stream analysis of activity occurring within the monitored environment at any given moment. Activity log table 1004 may be architecturally separate from the system's primary database, and may operate as a dedicated, high-throughput structure optimized for real-time event ingestion and query. It may be instance-scoped: each deployment maintains its own isolated activity log table 1004, with no data shared across deployment instances or user accounts. This isolation ensures that all event records, analytical conclusions, and downstream actions remain fully contained within the boundaries of the individual deployment, in accordance with the platform's privacy and data segregation principles.

With continued reference to FIG. 10, Log and Notification process 1000 may include a log watcher 1006. Log watcher 1006 may be an analytical core of the Log and Notification process 1000. It may operate as a continuous monitoring component that observes activity log table 1004 in real time. It may read incoming event records as they are written by the worker 1002. Rather than evaluating events individually, the log watcher 1006 may assess the full scope of current activity within the table, correlating outputs across multiple upstream processes, incorporating historical data associated with any identified individuals, and synthesizing all available data points into a coherent, contextual understanding of what is occurring within the monitored environment at any given moment. The resulting output may take the form of structured, actionable insights that serve as the basis for all downstream notification, access control, and integration decisions.

With continued reference to FIG. 10, log watcher 1006 may include an LLM 1008. In some embodiments, LLM 1008 may serve as the reasoning layer of log watcher 1006. LLM 1008 may receive structured event data and contextual inputs assembled by a log analysis 1010 component and is responsible for interpreting that information in natural language terms; producing coherent, human-readable summaries of current activity within the frame, assessing the nature and significance of detected events, and generating actionable conclusions that downstream pipeline stages can evaluate against the user configuration. LLM 1008's ability to reason across multiple data points simultaneously (including, as non-limiting examples, concurrent detections from independent upstream processes, identified individuals' historical activity records, and temporal patterns within the current session) enables the pipeline to produce assessments that reflect the full context of a situation rather than responding to isolated signals. Its outputs are structured to be both machine-parseable for automated downstream processing and human-readable for operator review and audit.

With continued reference to FIG. 10, log watcher 1006 may include log analysis 1010. Log analysis 1010 component may serve as a structured validation layer operating in conjunction with LLM 1008, responsible for evaluating the LLM's outputs for coherence, accuracy, and completeness before those conclusions are passed downstream. Log analysis 1010 may scrutinize the LLM's generated assessments, verifying that the produced summaries and actionable insights are consistent with the underlying event data in activity log table 1004, that detected events have been correctly accounted for and appropriately weighted, and that the resulting conclusions represent a proper roll-up of all active signals rather than an incomplete or contradictory interpretation. In some embodiments, verifying the machine-parseable output may include comparing the machine-parseable output against the activity log table. Where discrepancies or incoherence are identified between LLM 1008's output and the source event record, log analysis 1010 may flag or reject the assessment, thereby triggering a re-evaluation cycle. This validation step ensures that only well-formed, internally consistent, and data-grounded insights are advanced to the downstream configuration evaluation and action execution stages of the pipeline, maintaining the integrity and reliability of all conclusions produced by the log watcher 1006.

With continued reference to FIG. 10, in some embodiments, following log watcher 1006's analytical cycle, Log and Notification process 1000 may include writing the latest event records and their corresponding derived insights to the application logs. This update makes the current state of activity within the monitored environment visible to the user in real-time through the platform interface, presenting both the raw event data and the LLM-generated summaries in a human-readable format. The app logs serve as the user-facing representation of the activity log table 1004's contents, providing operators with an accessible, continuously updated view of what is occurring within the frame without requiring direct interaction with the underlying pipeline infrastructure.

With continued reference to FIG. 10, Log and Notification process 1000 may include checking notification preferences 1012 for a user. This may include evaluating the current insights and active event records against user configuration file 1014. User configuration file 1014 may define the conditions, thresholds, and rules that govern when and how the system is permitted to act, specifying which event types, severity levels, detection categories, or combinations thereof are designated to trigger a response. The pipeline cross-references the log watcher 1006's conclusions against these user-defined parameters to determine whether any actionable conditions have been met. This evaluation may result in one or more downstream actions being queued (including, but not limited to: user notifications, access control triggers, and IoT integrations) or in no action being taken if the current activity does not satisfy any configured threshold. Where a notification has been determined necessary, Log and Notification process 1000 may notify user 1018 by invoking the notification service, which is responsible for delivering the alert to the user through their configured notification channels. The notification payload 1016 may include the relevant event data and derived insights, providing the user with sufficient context to understand the nature of the detected activity and assess any required response. The notification service may operate independently of the core pipeline, ensuring that delivery does not block or delay continued event ingestion and processing.

With continued reference to FIG. 10, logs and notification process may include comparing, using the at least one processor, the updated application log against a set of user preferences from a user configuration file 1014. For example, user preferences may include what known entities should have the door unlocked for them, what known entities should have an alert generated if they are spotted, what types of threats and threat levels are acceptable, or the like, as non-limiting examples. This may further include, in some embodiments, executing, using the at least one processor, one or more automated actions as a function of the comparison between user configuration file. Automated actions may include generating notifications, generating alarms, locking doors, unlocking doors, calling 911 or the police, and the like.

With continued reference to FIG. 10, in some embodiments, the full Activity Log (comprising the complete record of all events ingested and processed within the current cycle) is retained by the platform on a short-term basis only. In some embodiments, prior to the log rollup 1020, which may purge granular event data in favor of aggregated records, users may access their account at any time to export the full Activity Log in its complete form (see user download available history 1022).

With continued reference to FIG. 10, The full Activity Log, comprising the complete set of event-level data collected and processed by the system, may be retained by a system owner for a limited duration (e.g., several days). Following this retention period, log rollup 1020 may be executed. This process may systematically aggregate and condense the granular event data into summarized records, which are stored as a master entry within the database corresponding to each identified individual. This aggregated data 1024 may be stored in database 1026. Upon completion of log rollup 1020 process, the underlying detailed event-level records may be deleted from active storage. This approach preserves all relevant analytical insights and derived information for long term reference while minimizing storage overhead and reducing computational complexity associated with maintaining and querying large volumes of raw event data.

### Encode New Face Process

Referring back to FIG. 1, if a person is not found in any of the encoding files, as described further for exemplary facial recognition process 900, then layered surveillance system 100 may use encode new face process 1100.

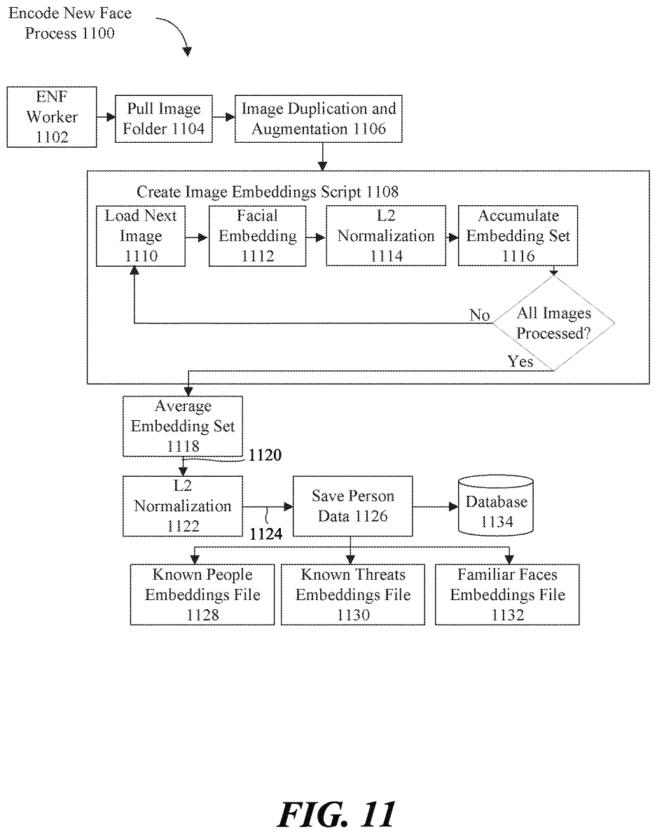

Referring now to FIG. 11, a flow diagram of an exemplary encode new face process 1100 is shown. Encode new face process 1100 may accept, in embodiments, two distinct input structures depending on the enrollment trigger. For automatically initiated enrollments, the process may receive the user context, a preliminary tracking ID assigned to the unidentified individual, and the associated image folder generated by the snapshot module. For manually initiated enrollments, the process may receive the user context, the submitted person's metadata, and an image folder containing the user-uploaded images of the individual being registered

With continued reference to FIG. 11, encode new face (ENF) process 1100 may include an ENF worker 1102. ENF worker 1102 may serve as the entry point for encode new face process 1100, responsible for receiving the input data and orchestrating its passage through each subsequent stage of the enrollment workflow.

With continued reference to FIG. 11, encode new face process 1100 may pull image folder 1104. Regardless of whether enrollment (encoding the new face) was triggered automatically by the system or manually by a user, encode new face process 1100 may begin by retrieving an image folder associated with the individual being enrolled, which may include the collected face images to be processed.

With continued reference to FIG. 11, encode new face process 1100 may perform image duplication and augmentation 1106. Facial recognition systems do not always operate under optimal conditions, as real-world environments introduce variations in lighting, camera quality, distance, and facial orientation. To improve robustness and reliability, an image augmentation process may be applied prior to generating facial embeddings for future comparisons. During image duplication and augmentation 1106, captured images (representing different angles and perspectives of an individual's face) may be duplicated and may be systematically modified using a range of filters. These transformations may simulate real-world variations such as changes in lighting conditions (e.g., low light, overexposure), visibility (e.g., blur, noise), and/or contrast. Additional augmentations may include slight rotations, scaling, and/or adjustments in brightness or sharpness. The purpose of this augmentation may be to artificially expand the diversity of the dataset, allowing the facial recognition model to learn more generalized and invariant facial features. By exposing the system to these simulated conditions, it may become more capable of accurately identifying individuals across a wide range of environments and visual distortions, ultimately improving recognition accuracy and reducing false negatives in non-ideal scenarios.

With continued reference to FIG. 11, encode new face process 1100 may include a create image embeddings script 1108. Create image embeddings script 1108 may be responsible for converting each processed facial image into a mathematical representation that can be stored and used for later recognition. Rather than comparing raw image files directly, create image embeddings script 1108 may translate each face into a standardized numerical embedding. This may allow facial comparisons to be performed more efficiently and with greater accuracy, even when the source images differ slightly in angle, lighting, or quality.

With continued reference to FIG. 11, create image embeddings script 1108 may include loading next image 1110. This may include loading in the next image from a prepared image set and putting it in the processing queue.

With continued reference to FIG. 11, create image embeddings script 1108 may include performing facial embedding 1112. This may be consistent with the processes described for facial embedding 926.

With continued reference to FIG. 11, create image embeddings script 1108 may include L2 normalization 1114. The embeddings generated from different images may naturally vary in magnitude, even when they represent the same individual. If these vectors remain on different scales, averaging them or combining them into a final representative embedding can produce inconsistent or unreliable results. To address this issue, each embedding may, in some embodiments, be passed through an L2 normalization 1114 step. L2 normalization may scale the embedding to unit length, by projecting the embedding onto a unit hypersphere by dividing the vector by its L2 norm. This may preserve the directional information of the vector, which contains the most meaningful facial identity features, while removing magnitude differences that could distort comparison results. As a result, all embeddings are placed on a consistent scale, making similarity calculations more stable and improving the quality of any averaged or final combined embedding. This step may be important for ensuring that the final facial representation is both mathematically consistent and suitable for accurate future matching.

With continued reference to FIG. 11, create image embeddings script 1108 may be configured to accumulate embedding sets 1116. Each newly generated embedding (facial embedding 1112) may be appended to a cumulative collection representing the full set of embeddings for the subject. This collection may be maintained for the purpose of computing a final, averaged embedding once all initial embeddings have been generated and validated. Upon processing all images within the input set, create image embeddings script 1108 may terminate and proceed to averaging embedding set 1118. If unprocessed images remain, the workflow may loop back to next image 1110.

With continued reference to FIG. 11, encode new face process 1100 may include averaging embedding set 1118. In some embodiments, once all embeddings in the set have been generated and accumulated, they may be aggregated into a single representative embedding vector. This may be accomplished by computing the element-wise mean across the full set of embeddings (e.g., np. mean(embeddings, axis=0) ), producing a unified representation of the individual's facial features. The resulting averaged embedding 1120 captures variations across different images, including changes in angle, lighting, and expression, thereby improving overall robustness and recognition accuracy in downstream processes.

With continued reference to FIG. 11, after averaged embedding 1120 is determined, it may go through L2 normalization 1122. Following the aggregation of embeddings, the resulting vector may exhibit variations in scale that can negatively impact comparison consistency. L2 normalization 1122 may be consistent with L2 normalization 1114.

With continued reference to FIG. 11, after L2 normalization 1122, final embedding 1124 may enter save person data 1126 step. Upon generation and normalization of final embedding 1124, encode new face process 1100 may persist the data by storing the embedding in the appropriate repository (known people embeddings file 1128, known threats embedding file 1130, and/or familiar faces embeddings file 1132) based on its designated classification (e.g., Known People, Known Threats, or Familiar Faces). Each embedding may be saved alongside a uniquely generated identifier (unique ID) to ensure consistent reference across the system. In parallel, this unique ID, along with, in some embodiments, all relevant metadata (such as name, attributes, and classification), may be recorded within database 1134. This dual-storage approach ensures both efficient embedding retrieval for real-time comparison and reliable metadata management for identification, auditing, and system-wide consistency.

### Exemplary Machine-Learning Module and Neural Network

Referring now to FIG. 12, an exemplary embodiment of a machine-learning module 1200 is shown. Machine-learning module 1200 may be configured to perform one or more machine learning processes as described throughout this disclosure. Machine-learning module 1200 may perform determinations, classification, and/or analysis steps, methods, processes, or the like as described in this disclosure using machine learning processes. A “machine learning process,” as used in this disclosure, is a process that automatedly uses training data 1205 to generate one or more machine-learning models 1210.

With continued reference to FIG. 12, for the purposes of this disclosure, “training data” is data that contains correlations that a machine-learning process may use to model relationships between two or more types of data. For example, training data 1205 may include one or more training examples. Multiple data entries in training data 1205 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. In some embodiments, training data 1205 may include input training data correlated to output training data. Elements in training data 1205 may be linked to descriptors of categories by tags, tokens, or other data elements; for instance, and without limitation, training data 1205 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

With continued reference to FIG. 12, in some embodiments, training data 1205 may be divided into different formats, categories, and/or groups. For example, in some embodiments, training data 1205 may be divided into one or more cohorts, categorizations, time periods, data sources, and the like. In some embodiments, training data 1205 may be assigned to categories using a classifier; as a non-limiting example, a training data classifier. Training data classifier may include a machine-learning module as described elsewhere with respect to FIG. 12. For example, in some embodiments, training data 1205 may be input into training data classifier and training data classifier may output a classification. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 1200 may generate a classifier using a classification algorithm, defined as a processes whereby a computing device and/or any module and/or component operating thereon derives a classifier from training data 1205. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With continued reference to FIG. 12, training data 1205 may be retrieved, in some embodiments, from a data structure 1215. A data structure 1215 may be remote to a computing device and communicative with a computing device by way of one or more networks. Network may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud,” e.g., via the Internet, rather than on local servers or personal computers. A “mesh network” as used in this disclosure is a local network topology in which the infrastructure a computing device connect directly, dynamically, and non-hierarchically to as many other computing devices as possible. A “network topology” as used in this disclosure is an arrangement of elements of a communication network. data structure 1215 may be implemented, without limitation, as a relational database, a key-value retrieval database such as a NOSQL database, or any other format or structure for use as a database that a person skilled in the art would recognize as suitable upon review of the entirety of this disclosure. data structure 1215 may alternatively or additionally be implemented using a distributed data storage protocol and/or data structure, such as a distributed hash table or the like. data structure 1215 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure. In an embodiment, data structure 1215 may be a generic storage mechanism. A generic storage mechanism may be a storage system or method that is not specific to any particular type or format of data, that is, a storage solution that provides a flexible and adaptable way to store and retrieve data without being tied to a specific data format, schema, or domain. In some embodiments, training data 1205 may be stored in data structure 1215. In some embodiments, training data 1205 may be retrieved from data structure 1215.

With continued reference to FIG. 12, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

With continued reference to FIG. 12, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

With continued reference to FIG. 12, a “machine-learning model,” as used in this disclosure, is a data structure representing and/or instantiating a mathematical and/or algorithmic representation of a relationship between inputs and outputs as generated using any machine-learning process. For example, machine-learning process may include, without limitation, any machine-learning process described in this disclosure.

With continued reference to FIG. 12, machine-learning process may include an unsupervised machine-learning process 1220. An unsupervised machine-learning process, as used herein, is a process that derives inferences in datasets without regard to labels; as a result, an unsupervised machine-learning process may be free to discover any structure, relationship, and/or correlation provided in the data. Unsupervised processes machine-learning process 1220 may not require a response variable; unsupervised processes machine-learning process 1220 may be used to find interesting patterns and/or inferences between variables, to determine a degree of correlation between two or more variables, or the like.

With continued reference to FIG. 12, machine-learning process may include a supervised machine-learning process 1225. Supervised machine-learning process 1225 may use training data 1205 with both exemplary inputs and expected outputs and use that training data 1205 to train a machine-learning model 1210. For example, during a training process, machine learning process may evaluate an actual output generated by machine-learning model 1210 and compare it to an expected output from training data 1205. Based on the difference between the actual and expected outputs, one or more weights within machine-learning model 1210 may be updated. For example, in some cases a scoring function may be used to train machine-learning model 1210. Scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 1205.

With continued reference to FIG. 12, machine-learning process may include a lazy-learning process 1230. Lazy learning is a machine-learning approach in which the model delays generalization until a query is made. For example, this can be rather than learning a global model during training. Instead of building an abstract representation of the data up front, a lazy learner may store the training instances and wait until it needs to make a prediction. For example, when a new input arrives, the system may perform computation on the fly. Because no heavy training occurs in advance, lazy-learning algorithms may be fast to set up but can be computationally expensive at prediction time and often require storing large datasets in memory. An example may include k-nearest neighbors (k-NN), which classifies new points based on the labels of their closest neighbors in the stored data. Lazy learning may adapt naturally to new data because the “model” is effectively the dataset itself, but this also means it can be sensitive to noise and may not scale well with very large datasets.

With continued reference to FIG. 12, in some embodiments, machine-learning module 1200 may receive external feedback 1235. External feedback 1235 may include, as a non-limiting example, feedback received from a user. In some embodiments, external feedback 1235 may be received through a user interface (such as, for example, a graphical user interface (GUI).

With continued reference to FIG. 12, machine-learning module 1200 may be configured to re-train machine-learning model 1210. In some embodiments, re-training machine-learning model 1210 may include re-training machine-learning model 1210 as a function of external feedback 1235. In some embodiments, external feedback 1235 may serve as a source of labeled or partially labeled data that reflects how the model performs in real-world conditions. For example, if a user provides negative external feedback 1235, then the set of data from training data 1205 may be assigned a negative label. In some embodiments, external feedback 1235 may include users correcting an output 1240 of machine-learning model 1210—such as flagging an incorrect prediction, choosing a preferred recommendation, or providing explicit labels. These interactions can be collected and added back into the training dataset. Over time, this additional data may help the model adapt to new patterns, correct systematic errors, and better align with user expectations. The re-training process may include cleaning and validating external feedback 1235, merging it with existing datasets such as training data 1205, and/or periodically running a new training cycle to update model parameters.

With continued reference to FIG. 12, machine-learning module 1200 may be configured to validate machine-learning model 1210. In some embodiments, machine-learning module 1200 may validate machine-learning model 1210 using validation data 1245. Validation data 1245 may be a subset of data used to train machine-learning model 1205. For example, validation data 1245 may include a subset of training data 1205. In some embodiments, validation data 1245 may include a percentage of training data 1205. As non-limiting example, validation data 1245 may include 1%,2%, 5%, 10%, 20%, 30%, and the like of training data 1205. In some embodiments, machine-learning model 1210 may not be exposed to validation data 1245 during training. Validation data 1245 may acts as a checkpoint that helps determine whether the model is generalizing well or simply memorizing training data 1205. As the model learns, its performance on the validation set may be monitored to guide decisions such as choosing hyperparameters, selecting architectures, adjusting regularization strength, or determining when to stop training to avoid overfitting.

With continued reference to FIG. 12, machine-learning model 1210 may be configured to receive one or more inputs 1250 and generate, as a function of the one or more inputs 1250, one or more outputs 1240. Outputs 1240 may be presented to users for example trough user interfaces and/or GUIs. In some embodiments, external feedback 1235 may be received users as a function of output 1240.

With continued reference to FIG. 12, one or more, processes, machine-learning processes, actions, steps, or the like as disclosed above may be performed using dedicated hardware 1255. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware 1255 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware 1255 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware 1255 to perform one or more operations described herein, such as evaluation of model and/or algorithm outputs, one-time or iterative updates to parameters, coefficients, weights, and/or biases, and/or any other operations such as vector and/or matrix operations as described in this disclosure.

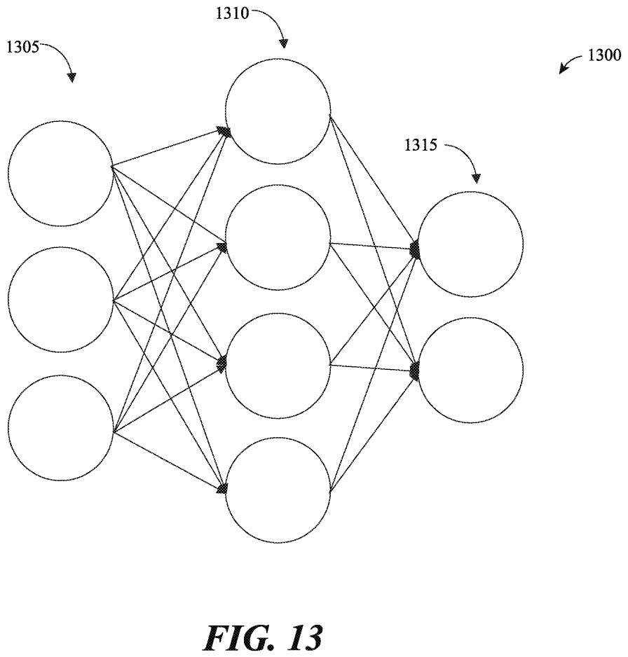

Referring now to FIG. 13, an exemplary embodiment of neural network 1300 is illustrated. A neural network 1300 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 1305, one or more intermediate layers 1310, and an output layer of nodes 1315. Connections between nodes may be created using a process of “training” the network, in which elements from a training dataset may applied to the input nodes. A suitable training algorithm (such as Levenberg-Marquardt, conjugate gradient, simulated annealing, or other algorithms) may then be used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

### Layered Surveillance Method

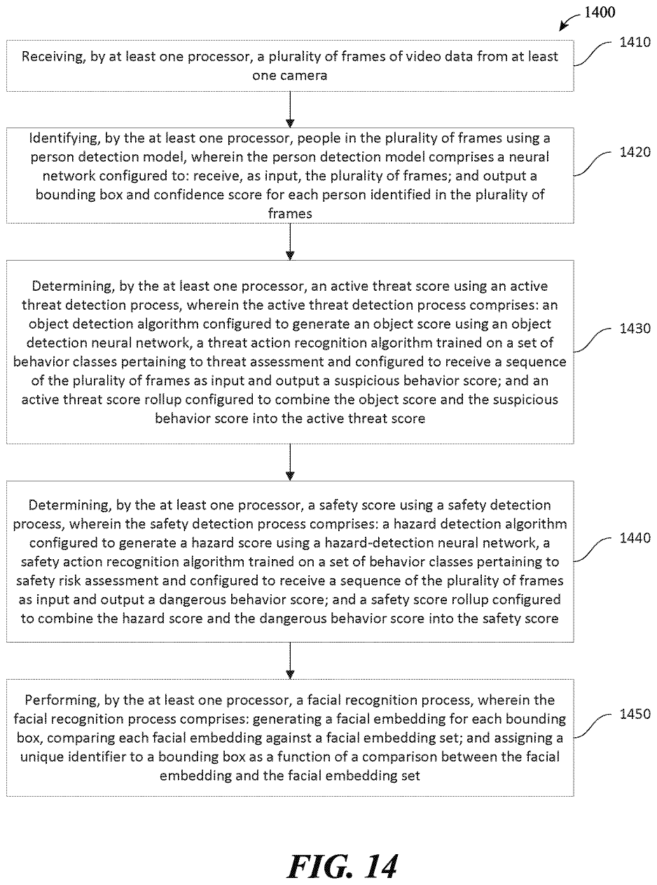

Referring now to FIG. 14, an exemplary method 1400 for layered surveillance is shown. Exemplary method 1400 may include a step 1410 of receiving, by at least one processor, a plurality of frames of video data from at least one camera. This may be performed, without limitation, as described with reference to any of FIGS. 1-13.

With continued reference to FIG. 14, exemplary method 1400 may include a step 1420 of identifying, by the at least one processor, people in the plurality of frames using a person detection model, wherein the person detection model includes a neural network configured to: receive, as input, the plurality of frames; and output a bounding box and confidence score for each person identified in the plurality of frames. This may be performed, without limitation, as described with reference to any of FIGS. 1-13.

With continued reference to FIG. 14, exemplary method 1400 may include a step 1430 of determining, by the at least one processor, an active threat score using an active threat detection process, wherein the active threat detection process includes: an object detection algorithm configured to generate an object score using an object detection neural network; a threat action recognition algorithm trained on a set of behavior classes pertaining to threat assessment and configured to receive a sequence of the plurality of frames as input and output a suspicious behavior score; and an active threat score rollup configured to combine the object score and the suspicious behavior score into the active threat score. This may be performed, without limitation, as described with reference to any of FIGS. 1-13.

With continued reference to FIG. 14, exemplary method 1400 may include a step 1440 of determining, by the at least one processor, a safety score using a safety detection process, wherein the safety detection process includes: a hazard detection algorithm configured to generate a hazard score using a hazard-detection neural network; a safety action recognition algorithm trained on a set of behavior classes pertaining to safety risk assessment and configured to receive a sequence of the plurality of frames as input and output a dangerous behavior score; and a safety score rollup configured to combine the hazard score and the dangerous behavior score into the safety score. This may be performed, without limitation, as described with reference to any of FIGS. 1-13.

With continued reference to FIG. 14, exemplary method 1400 may include a step 1450 of performing, by the at least one processor, a facial recognition process, wherein the facial recognition process includes: generating a facial embedding for each bounding box; comparing each facial embedding against a facial embedding set; and assigning a unique identifier to a bounding box as a function of a comparison between the facial embedding and the facial embedding set. This may be performed, without limitation, as described with reference to any of FIGS. 1-13.

In some aspects, the techniques described herein relate to a method, wherein the object detection algorithm is configured to: dynamically generate a subregion of an image of the plurality of frames of video data, wherein the subregion corresponds to a bounding box from the person detection model; using the object detection neural network: receive the subregion as input; and assign a threat-specific object class to the subregion; and using a concealment classification model operating in parallel with the object detection algorithm, identify visual indicators associated with identity concealment.

In some aspects, the techniques described herein relate to a method, wherein generating the object score using the object detection neural network includes: retrieving a temporal context store associated with the unique identifier; and generating the object score as a function of the temporal context store, the threat-specific object class, and the visual indicators associated with identity concealment.

In some aspects, the techniques described herein relate to a method, wherein determining the active threat score using the active threat detection process further includes: detecting a license plate number, wherein detecting a license plate number includes: detecting license plate regions within a frame of the plurality of frames using a localization model; and performing optical character recognition on a license plate region to extract a license plate number; determining a scene anomaly, wherein determining a scene anomaly includes: receiving a frame of the plurality of frames, wherein the frame is associated with a scene; retrieving a baseline representation of the scene; and determining an anomaly deviation by performing pixel-level signal processing to compare the frame to the baseline representation; performing a location analysis, wherein performing the location analysis includes: receiving track data from a tracking algorithm, wherein the track data includes historical positional data for a tracked entity; predicting a future trajectory for the tracked entity as a function of its track data; and determining a proximity score for the tracked entity as a function of comparing the future trajectory to a plurality of risk proximity zones; wherein the active threat score rollup is configured to combine the object score, the suspicious behavior score, the license plate number, the scene anomaly, and the proximity score, into the active threat score.

In some aspects, the techniques described herein relate to a method, wherein determining the active threat score using the active threat detection process further includes: identify sound events using a sound event detection model as a function of an audio buffer associated with the plurality of frames; and classifying the identified sound events to event classes using an audio event classifier; and assigning a threat audio score to the event classes; wherein the active threat score rollup is configured to combine the object score, the suspicious behavior score, and the threat audio score.

In some aspects, the techniques described herein relate to a method, wherein determining the safety score using the safety detection process further includes: determining a scene anomaly, wherein determining a scene anomaly includes: receiving a frame of the plurality of frames, wherein the frame is associated with a scene; retrieving a baseline representation of the scene; and determining an anomaly deviation by performing pixel-level signal processing to compare the frame to the baseline representation; performing a location analysis, wherein performing the location analysis includes: receiving track data from a tracking algorithm, wherein the track data includes historical positional data for a tracked entity; predicting a future trajectory for the tracked entity as a function of its track data; and determining a proximity score for the tracked entity as a function of comparing the future trajectory to a plurality of hazard proximity zones; wherein the safety score rollup is configured to combine the hazard score, the dangerous behavior score, the scene anomaly, and the proximity score, into the safety score.

In some aspects, the techniques described herein relate to a method, further including matching, using the at least one processor, each bounding box to an existing tracked entity, wherein matching each bounding box to the existing tracked entity includes: calculating a deep appearance descriptor for the existing tracked entity using a neural network; predicting a location of the existing tracked entity using a Kalman filter; comparing the predicted location of the existing tracked entity to a location of the bounding box; and comparing the deep appearance descriptor for the existing tracked entity to an embedding of the bounding box.

In some aspects, the techniques described herein relate to a method, wherein receiving the plurality of frames of video data from the at least one camera includes: receiving camera streams from a plurality of cameras, wherein each camera of the plurality of cameras is configured to output a camera stream; tagging each frame received from the camera with a camera identifier associated with that camera; assigning an incrementing sequence number to each frame received from the camera; and assembling one frame from each healthy camera stream into a single batch structure.

In some aspects, the techniques described herein relate to a method, further including performing a passive threat detection process, wherein the passive threat detection process includes: performing an image analysis, wherein the image analysis includes: inputting a plurality of facial features extracted from a frame into an image analysis model; and receiving as output from the image analysis model, a set of estimated demographic characteristics and an artificial generation likelihood score; performing a reverse facial lookup, wherein performing the reverse facial lookup includes: querying a revise facial lookup API using the plurality of facial features; and receiving a set of results as a function of the confidence scores and the reverse facial lookup API.

In some aspects, the techniques described herein relate to a method, wherein the passive threat detection process further includes a passive threat score rollup including aggregating the set of results and the set of estimated demographic characteristics into a results dataset.

In some aspects, the techniques described herein relate to a method, further comprising: receiving, using the at least one processor, incoming event records through an activity log table, wherein the incoming event records are generated by the safety detection process, the active threat detection process, and a facial recognition process; generating, using the at least one processor, a machine-parseable output using a large language model (LLM) from the incoming event records, wherein the machine-parseable output comprises an assessment of the incoming event records; verifying, using the at least one processor, the machine-parseable output by comparing the machine-parseable output against the activity log table; updating, using the at least one processor, an application log as a function of the verification of the machine-parseable output; comparing, using the at least one processor, the updated application log against a set of user preferences from a user configuration file; and executing, using the at least one processor, one or more automated actions as a function of the comparison between user configuration file.

In some aspects, the techniques described herein relate to a method, further comprising applying, using the at least one processor, a plurality of filters to a new face image to produce duplicate images; generating, using the at least one processor, duplicate image embeddings for the duplicate images; generating, using the at least one processor, a final embedding by averaging all of the duplicate image embeddings for the new face image; and storing, using the at least one processor, the final embeddings file in a known person repository.

### An Embodiment of a Computing Device in the Exemplary Form of a Computer System

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

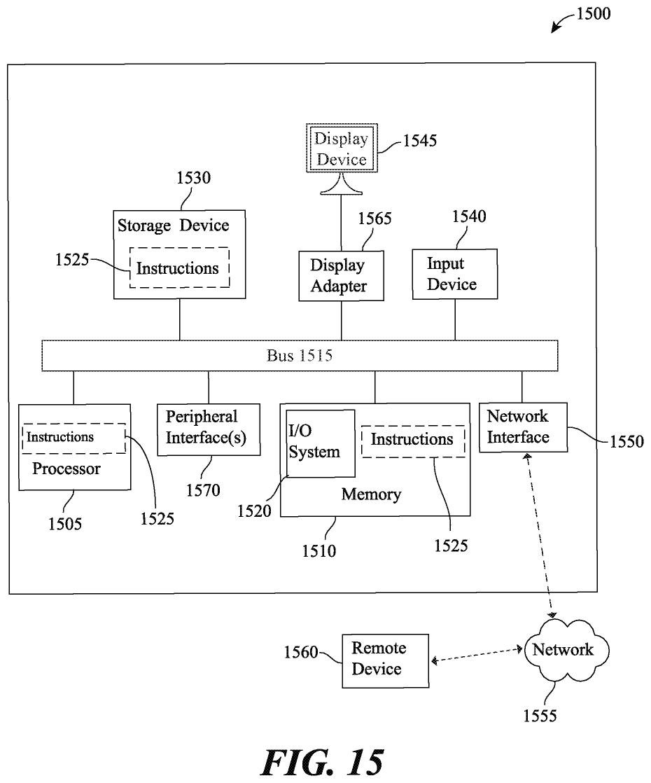

FIG. 15 shows a diagrammatic representation of one embodiment of a computing device in the exemplary form of a computer system 1500 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1500 includes a processor 1505 and a memory 1510 that communicate with each other, and with other components, via a bus 1515. Bus 1515 may include any of several types of bus structures including, but not limited to, a memory bus, a memory controller, a peripheral bus, a local bus, and any combinations thereof, using any of a variety of bus architectures.

Processor 1505 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1505 may be organized according to Von Neumann and/or Harvard architecture as a non-limiting example. Processor 1505 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo's algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 1510 may include various components (e.g., machine-readable media) including, but not limited to, a random-access memory component, a read only component, and any combinations thereof. In one example, a basic input/output system 1520 (BIOS), including basic routines that help to transfer information between elements within computer system 1500, such as during start-up, may be stored in memory 1510. Memory 1510 may also include (e.g., stored on one or more machine-readable media) instructions (e.g., software) 1525 embodying any one or more of the aspects and/or methodologies of the present disclosure. In another example, memory 1510 may further include any number of program modules including, but not limited to, an operating system, one or more application programs, other program modules, program data, and any combinations thereof. Memory 1510 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 1500 may also include a storage device 1530. Examples of a storage device (e.g., storage device 1530) include, but are not limited to, a hard disk drive, a magnetic disk drive, an optical disc drive in combination with an optical medium, a solid-state memory device, and any combinations thereof. Storage device 1530 may be connected to bus 1515 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1530 (or one or more components thereof) may be removably interfaced with computer system 1500 (e.g., via an external port connector (not shown)). Particularly, storage device 1530 and an associated machine-readable medium may provide nonvolatile and/or volatile storage of machine-readable instructions, data structures, program modules, and/or other data for computer system 1500. In some embodiments, storage device 1530 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software (e.g., instructions 1525) may reside, completely or partially, within machine-readable medium. In another example, software may reside, completely or partially, within processor 1505.

Computer system 1500 may also include an input device 1540. In one example, a user of computer system 1500 may enter commands and/or other information into computer system 1500 via input device 1540. Examples of an input device 1540 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1540 may be interfaced to bus 1515 via any of a variety of interfaces (not shown) including, but not limited to, a serial interface, a parallel interface, a game port, a USB interface, a FIREWIRE interface, a direct interface to bus 1515, and any combinations thereof. Input device 1540 may include a touch screen interface that may be a part of or separate from display 1545, discussed further below. Input device 1540 may be utilized as a user selection device for selecting one or more graphical representations in a graphical interface as described above.

A user may also input commands and/or other information to computer system 1500 via storage device 1530 (e.g., a removable disk drive, a flash drive, etc.) and/or network interface device 1550. A network interface device, such as network interface device 1550, may be utilized for connecting computer system 1500 to one or more of a variety of networks, such as network 1555, and one or more remote devices 1560 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1555, may employ a wired and/or a wireless mode of communication. In general, any network topology may be used. Information (e.g., data, software, etc.) may be communicated to and/or from computer system 1500 via network interface device 1550.

Computer system 1500 may further include a video display adapter 1565 for communicating a displayable image to a display device, such as display 1545. Examples of a display device include, but are not limited to, a liquid crystal display (LCD), a cathode ray tube (CRT), a plasma display, a light emitting diode (LED) display, and any combinations thereof. Display adapter 1565 and display 1545 may be utilized in combination with processor 1505 to provide graphical representations of aspects of the present disclosure. In addition to a display device, computer system 1500 may include one or more other peripheral output devices including, but not limited to, an audio speaker, a printer, and any combinations thereof. Such peripheral output devices may be connected to bus 1515 via a peripheral interface 1570. Examples of a peripheral interface include, but are not limited to, a serial port, a USB connection, a FIREWIRE connection, a parallel connection, and any combinations thereof.

Further referring to FIG. 15, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 15, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 15, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 1500, processor 1505, and memory 1510 may be virtualized; that is, a virtual machine and/or container may interact directly with such computing system 1500, processor 1505, and/or memory 1510, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 1505 comprises a plurality of processors and/or processor cores, virtualization may, in some cases, simulate or emulate a single (virtual) processor whose functions are allocated to one or more of the plurality of processors and/or processor cores. In this case, while processor 1505 may be said to be virtualized, the processor 1505, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, as discussed above, it should be understood that the particular systems and methods used to implement the disclosure may be modified without changing the spirit of the disclosure, and as such the various art-recognized alternatives are within the scope of the present application.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

### Equivalents

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

What is claimed is:

1. A layered surveillance system, the layered surveillance system comprising:
at least one camera, wherein the at least one camera is configured to capture a plurality of frames of video data;
at least one processor; and
a memory communicatively connected to the at least one processor, wherein the memory contains instructions configuring the at least one processor to:
receive the plurality of frames of video data from the at least one camera;
identify people in the plurality of frames using a person detection model, wherein the person detection model comprises a neural network configured to:
receive, as input, the plurality of frames; and
output a bounding box and confidence score for each person identified in the plurality of frames;
determine an active threat score using an active threat detection process, wherein the active threat detection process comprises:
an object detection algorithm configured to generate an object score using an object detection neural network;
a threat action recognition algorithm trained on a set of behavior classes pertaining to threat assessment and configured to receive a sequence of the plurality of frames as input and output a suspicious behavior score;
an active threat score rollup configured to combine the object score and the suspicious behavior score into the active threat score;
determine a safety score using a safety detection process, wherein the safety detection process comprises:
a hazard detection algorithm configured to generate a hazard score using a hazard-detection neural network;
a safety action recognition algorithm trained on a set of behavior classes pertaining to safety risk assessment and configured to receive a sequence of the plurality of frames as input and output a dangerous behavior score;
a safety score rollup configured to combine the hazard score and the dangerous behavior score into the safety score;
perform a facial recognition process, wherein the facial recognition process comprises:
generating a facial embedding for each bounding box;
comparing each facial embedding against a facial embedding set; and
assigning a unique identifier to a bounding box as a function of a comparison between the facial embedding and the facial embedding set.

2. The system of claim 1, wherein the object detection algorithm is configured to:
dynamically generate a subregion of an image of the plurality of frames of video data, wherein the subregion corresponds to a bounding box from the person detection model;
using the object detection neural network:
receive the subregion as input; and
assign a threat-specific object class to the subregion; and
using a concealment classification model operating in parallel with the object detection algorithm, identify visual indicators associated with identity concealment.

3. The system of claim 2, wherein generating the object score using the object detection neural network comprises:
retrieving a temporal context store associated with the unique identifier; and
generating the object score as a function of the temporal context store, the threat-specific object class, and the visual indicators associated with identity concealment.

4. The system of claim 1, wherein determining the active threat score using the active threat detection process further comprises:
detecting a license plate number, wherein detecting a license plate number comprises:
detecting license plate regions within a frame of the plurality of frames using a localization model; and
performing optical character recognition on a license plate region to extract a license plate number;
determining a scene anomaly, wherein determining a scene anomaly comprises:
receiving a frame of the plurality of frames, wherein the frame is associated with a scene;
retrieving a baseline representation of the scene; and
determining an anomaly deviation by performing pixel-level signal processing to compare the frame to the baseline representation;
performing a location analysis, wherein performing the location analysis comprises:
receiving track data from a tracking algorithm, wherein the track data includes historical positional data for a tracked entity;
predicting a future trajectory for the tracked entity as a function of its track data; and
determining a proximity score for the tracked entity as a function of comparing the future trajectory to a plurality of risk proximity zones;
wherein the active threat score rollup is configured to combine the object score, the suspicious behavior score, the license plate number, the scene anomaly, and the proximity score, into the active threat score.

5. The system of claim 1, wherein determining the active threat score using the active threat detection process further comprises:
identify sound events using a sound event detection model as a function of an audio buffer associated with the plurality of frames; and
classifying the identified sound events to event classes using an audio event classifier; and
assigning a threat audio score to the event classes;
wherein the active threat score rollup is configured to combine the object score, the suspicious behavior score, and the threat audio score.

6. The system of claim 1, wherein determining the safety score using the safety detection process further comprises:
determining a scene anomaly, wherein determining a scene anomaly comprises:
receiving a frame of the plurality of frames, wherein the frame is associated with a scene;
retrieving a baseline representation of the scene; and
determining an anomaly deviation by performing pixel-level signal processing to compare the frame to the baseline representation;
performing a location analysis, wherein performing the location analysis comprises:
receiving track data from a tracking algorithm, wherein the track data includes historical positional data for a tracked entity;
predicting a future trajectory for the tracked entity as a function of its track data; and
determining a proximity score for the tracked entity as a function of comparing the future trajectory to a plurality of hazard proximity zones;
wherein the safety score rollup is configured to combine the hazard score, the dangerous behavior score, the scene anomaly, and the proximity score, into the safety score.

7. The system of claim 1, wherein the memory contains instructions configuring the at least one processor to match each bounding box to an existing tracked entity, wherein matching each bounding box to the existing tracked entity comprises:
calculating a deep appearance descriptor for the existing tracked entity using a neural network;
predicting a location of the existing tracked entity using a Kalman filter;
comparing the predicted location of the existing tracked entity to a location of the bounding box; and
comparing the deep appearance descriptor for the existing tracked entity to an embedding of the bounding box.

8. The system of claim 1, wherein
the system comprises a plurality of cameras, wherein each camera of the plurality of cameras is configured to output a camera stream; and
receiving the plurality of frames of video data from the at least one camera comprises:
tagging each frame received from the camera with a camera identifier associated with that camera;
assigning an incrementing sequence number to each frame received from the camera; and
assembling one frame from each healthy camera stream into a single batch structure.

9. The system of claim 1, wherein the memory contains instructions further configuring the at least one processor to perform a passive threat detection process, wherein the passive threat detection process comprises:
performing an image analysis, wherein the image analysis comprises:
inputting a plurality of facial features extracted from a frame into an image analysis model; and
receiving as output from the image analysis model, a set of estimated demographic characteristics and an artificial generation likelihood score;
performing a reverse facial lookup, wherein performing the reverse facial lookup comprises:
querying a revise facial lookup API using the plurality of facial features; and
receiving a set of results as a function of the confidence scores and the reverse facial lookup API.

10. The system of claim 9, wherein the passive threat detection process further comprises a passive threat score rollup comprising aggregating the set of results and the set of estimated demographic characteristics into a results dataset.

11. The system of claim 1, wherein the memory contains instructions further configuring the at least one processor to:
receive incoming event records through an activity log table, wherein the incoming event records are generated by the safety detection process, the active threat detection process, and a facial recognition process;
generate a machine-parseable output using a large language model (LLM) from the incoming event records, wherein the machine-parseable output comprises an assessment of the incoming event records;
verify the machine-parseable output by comparing the machine-parseable output against the activity log table;
update an application log as a function of the verification of the machine-parseable output;
compare the updated application log against a set of user preferences from a user configuration file; and
execute one or more automated actions as a function of the comparison between user configuration file.

12. The system of claim 1, wherein the memory contains instructions configuring the at least a process to:
apply a plurality of filters to a new face image to produce duplicate images;
generate duplicate image embeddings for the duplicate images;
generate a final embedding by averaging all of the duplicate image embeddings for the new face image; and
store the final embeddings file in a known person repository.

13. A layered surveillance method, the layered surveillance method comprising:
receiving, by at least one processor, a plurality of frames of video data from at least one camera;
identifying, by the at least one processor, people in the plurality of frames using a person detection model, wherein the person detection model comprises a neural network configured to:
receive, as input, the plurality of frames; and
output a bounding box and confidence score for each person identified in the plurality of frames;
determining, by the at least one processor, an active threat score using an active threat detection process, wherein the active threat detection process comprises:
an object detection algorithm configured to generate an object score using an object detection neural network;
a threat action recognition algorithm trained on a set of behavior classes pertaining to threat assessment and configured to receive a sequence of the plurality of frames as input and output a suspicious behavior score; and
an active threat score rollup configured to combine the object score and the suspicious behavior score into the active threat score;
determining, by the at least one processor, a safety score using a safety detection process, wherein the safety detection process comprises:
a hazard detection algorithm configured to generate a hazard score using a hazard-detection neural network;
a safety action recognition algorithm trained on a set of behavior classes pertaining to safety risk assessment and configured to receive a sequence of the plurality of frames as input and output a dangerous behavior score; and
a safety score rollup configured to combine the hazard score and the dangerous behavior score into the safety score;
performing, by the at least one processor, a facial recognition process, wherein the facial recognition process comprises:
generating a facial embedding for each bounding box;
comparing each facial embedding against a facial embedding set; and
assigning a unique identifier to a bounding box as a function of a comparison between the facial embedding and the facial embedding set.

14. The method of claim 13, wherein the object detection algorithm is configured to:
dynamically generate a subregion of an image of the plurality of frames of video data, wherein the subregion corresponds to a bounding box from the person detection model;
using the object detection neural network:
receive the subregion as input; and
assign a threat-specific object class to the subregion; and
using a concealment classification model operating in parallel with the object detection algorithm, identify visual indicators associated with identity concealment.

15. The method of claim 14, wherein generating the object score using the object detection neural network comprises:
retrieving a temporal context store associated with the unique identifier; and
generating the object score as a function of the temporal context store, the threat-specific object class, and the visual indicators associated with identity concealment.

16. The method of claim 13, wherein determining the active threat score using the active threat detection process further comprises:
detecting a license plate number, wherein detecting a license plate number comprises:
detecting license plate regions within a frame of the plurality of frames using a localization model; and
performing optical character recognition on a license plate region to extract a license plate number;
determining a scene anomaly, wherein determining a scene anomaly comprises:
receiving a frame of the plurality of frames, wherein the frame is associated with a scene;
retrieving a baseline representation of the scene; and
determining an anomaly deviation by performing pixel-level signal processing to compare the frame to the baseline representation;
performing a location analysis, wherein performing the location analysis comprises:
receiving track data from a tracking algorithm, wherein the track data includes historical positional data for a tracked entity;
predicting a future trajectory for the tracked entity as a function of its track data; and
determining a proximity score for the tracked entity as a function of comparing the future trajectory to a plurality of risk proximity zones;
wherein the active threat score rollup is configured to combine the object score, the suspicious behavior score, the license plate number, the scene anomaly, and the proximity score, into the active threat score.

17. The method of claim 13, wherein determining the active threat score using the active threat detection process further comprises:
identify sound events using a sound event detection model as a function of an audio buffer associated with the plurality of frames; and
classifying the identified sound events to event classes using an audio event classifier; and
assigning a threat audio score to the event classes;
wherein the active threat score rollup is configured to combine the object score, the suspicious behavior score, and the threat audio score.

18. The method of claim 13, wherein determining the safety score using the safety detection process further comprises:
determining a scene anomaly, wherein determining a scene anomaly comprises:
receiving a frame of the plurality of frames, wherein the frame is associated with a scene;
retrieving a baseline representation of the scene; and
determining an anomaly deviation by performing pixel-level signal processing to compare the frame to the baseline representation;
performing a location analysis, wherein performing the location analysis comprises:
receiving track data from a tracking algorithm, wherein the track data includes historical positional data for a tracked entity;
predicting a future trajectory for the tracked entity as a function of its track data; and
determining a proximity score for the tracked entity as a function of comparing the future trajectory to a plurality of hazard proximity zones;
wherein the safety score rollup is configured to combine the hazard score, the dangerous behavior score, the scene anomaly, and the proximity score, into the safety score.

19. The method of claim 13, further comprising matching, using the at least one processor, each bounding box to an existing tracked entity, wherein matching each bounding box to the existing tracked entity comprises:
calculating a deep appearance descriptor for the existing tracked entity using a neural network;
predicting a location of the existing tracked entity using a Kalman filter;
comparing the predicted location of the existing tracked entity to a location of the bounding box; and
comparing the deep appearance descriptor for the existing tracked entity to an embedding of the bounding box.

20. The method of claim 13, wherein receiving the plurality of frames of video data from the at least one camera comprises:
receiving camera streams from a plurality of cameras, wherein each camera of the plurality of cameras is configured to output a camera stream;
tagging each frame received from the camera with a camera identifier associated with that camera;
assigning an incrementing sequence number to each frame received from the camera; and
assembling one frame from each healthy camera stream into a single batch structure.

21. The method of claim 13, further comprising performing a passive threat detection process, wherein the passive threat detection process comprises:
performing an image analysis, wherein the image analysis comprises:
inputting a plurality of facial features extracted from a frame into an image analysis model; and
receiving as output from the image analysis model, a set of estimated demographic characteristics and an artificial generation likelihood score;
performing a reverse facial lookup, wherein performing the reverse facial lookup comprises:
querying a revise facial lookup API using the plurality of facial features; and
receiving a set of results as a function of the confidence scores and the reverse facial lookup API.

22. The method of claim 21, wherein the passive threat detection process further comprises a passive threat score rollup comprising aggregating the set of results and the set of estimated demographic characteristics into a results dataset.

23. The method of claim 13, further comprising:
receiving, using the at least one processor, incoming event records through an activity log table, wherein the incoming event records are generated by the safety detection process, the active threat detection process, and a facial recognition process;
generating, using the at least one processor, a machine-parseable output using a large language model (LLM) from the incoming event records, wherein the machine-parseable output comprises an assessment of the incoming event records;
verifying, using the at least one processor, the machine-parseable output by comparing the machine-parseable output against the activity log table;
updating, using the at least one processor, an application log as a function of the verification of the machine-parseable output;
comparing, using the at least one processor, the updated application log against a set of user preferences from a user configuration file; and
executing, using the at least one processor, one or more automated actions as a function of the comparison between user configuration file.

24. The method of claim 13, further comprising:
applying, using the at least one processor, a plurality of filters to a new face image to produce duplicate images;
generating, using the at least one processor, duplicate image embeddings for the duplicate images;
generating, using the at least one processor, a final embedding by averaging all of the duplicate image embeddings for the new face image; and
storing, using the at least one processor, the final embeddings file in a known person repository.
